(19) United States
(12) Patent Application Publication
(10) Pub. No.: US 2024/0346156 A1
(43) Pub. Date: Oct. 17, 2024

(54) METHODS AND SYSTEMS OF ENCODING AN ARBITRARY ACCESS POLICY INTO DATA ENCRYPTION

(71) Applicant: RITESH AHUJA, cupertino, CA (US)

(72) Inventor: RITESH AHUJA, cupertino, CA (US)

(21) Appl. No.: 18/401,083

(22) Filed: Dec. 29, 2023

Related U.S. Application Data
(60) Provisional application No. 63/435,807, filed on Dec. 29, 2022.
(60) Provisional application No. 63/544,636, filed on Oct. 18, 2023.

(51) Int. Cl. G06F 21/60

(52) U.S. Cl. CPC G06F 21/602

(57) ABSTRACT

In another aspect, a computerized method comprising: generating a strong envelope around a user's private key using a Shamir's Secret Sharing technique on a plurality of simple passwords to generate a single complex secret through cryptographic intermingling of the multiple passwords; and intermingling of a subset of originally configured passwords to reconstruct the complex secret for decrypting the envelope around user's private key.

### CLAIM OF PRIORITY

This application claims priority to U.S. Provisional Application No. 63/435,807, titled METHODS AND SYSTEMS OF ENCODING AN ARBITRARY ACCESS POLICY INTO DATA ENCRYPTION and filed on 29 Dec. 2022. This provisional application is hereby incorporated by reference in its entirety.

This application claims priority to U.S. Provisional Application No. 63/544,636, titled METHODS AND SYSTEMS OF ENCODING AN ARBITRARY ACCESS POLICY INTO DATA ENCRYPTION and filed on 18 Oct. 2023. This provisional application is hereby incorporated by reference in its entirety.

### BACKGROUND

The internet was originally not built with security as its basis. For the internet, security is an afterthought. Currently, cybersecurity is often a “safe zone” built around a sensitive data using perimeter and access security, rather than protecting the data itself. Accordingly, there is a need to take a fresh look at the problem of internet data security and create a security fabric at a design level that is agnostic to, inter alia: data types, applications, operating systems, devices, etc. There is a need for an ability to imbed arbitrary fine-grained access policies into data itself at the object level, along with enterprise control.

### SUMMARY OF THE INVENTION

In one aspect, a computerized method of encoding an Arbitrary Access Policy into a data encryption, comprising: providing an encryption/decryption mechanism for any arbitrary combination comprising a list of groups or any arbitrary combination comprising a list of users and groups by: creating a hierarchy of lockboxes with a combination of a symmetric cryptographic techniques and an asymmetric cryptographic technique; directly implementing with the hierarchy of lockboxes the encryption/decryption mechanism into a data encryption logic by: setting an access policy for encoding into data encryption by the data owner or an administrator; after encrypting the data with a data encryption key, and subsequently encrypting the data encryption key for appropriate user or application, or group, or company, or some arbitrary combination thereof, writing the encrypted key into an appropriate set of user or group lockboxes; requesting a user key from lockbox as an attempt is made to access the data inside the application for presenting to the user; reading the encrypted key from user lockbox; which after decryption leading to encrypted key of next lockbox in the hierarchy, till retrieval of encrypted data encryption key itself, and returning the encrypted key retrieved from final lockbox for the final decryption operations inside an SDK integrated into the application, and wherein a resulting data and one or more encryption keys of the resulting are encoded in a plurality of layers of encryption as per the hierarchy corresponding to the specified access policy, and wherein once a policy is encoded into encryption, no trust is required in a centralized server to enforce these access policies, since data encryption keys are now controlled directly by the policy members.

In another aspect, a computerized method comprising: generating a strong envelope around a user's private key using a Shamir's Secret Sharing technique on a plurality of simple passwords to generate a single complex secret through cryptographic intermingling of the multiple passwords; and intermingling of a subset of originally configured passwords to reconstruct the complex secret for decrypting the envelope around user's private key.

In yet another aspect, a computerized method comprising: implementing a decentralized public-key validation of a stranger's public key, that is not yet trusted by the user, using one or more from a multitude of trusted services, which could be a centralized system controlled by an organization that the user trusts, or some decentralized identity service on top of a blockchain; or trusted friends of the user that are already in that user's trust circle leading to a chain of trust through friend of friends mechanism leading to inclusion of the stranger into that user's trust circle . . .

### BRIEF DESCRIPTION OF THE DRAWINGS

FIG. 1 illustrates an example DigiLockbox system used for encoding an arbitrary access policy into data encryption, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example DigiLockbox system, according to some embodiments.

FIG. 5 illustrates an example DigiLockbox process, according to some embodiments.

FIG. 6 illustrates an example risk-aware lockbox process, according to some embodiments.

FIG. 7 illustrates an example DigiLockbox SDK process, according to some embodiments.

FIG. 8 illustrates an example process of a DigiLockbox solution, according to some embodiments.

FIG. 9 illustrates an example process for key management, according to some embodiments.

FIG. 10 illustrates an example process for data encryption and privacy, according to some embodiments.

FIGS. 11 and 12 show example screenshots, according to some embodiments.

FIG. 13 illustrates an example process for basic locking/unlocking with lockboxes, according to some embodiments.

FIG. 14 illustrates an example process for implementing a basic data locking, according to some embodiments.

FIG. 15 illustrates an example process for a basic data unlocking, according to some embodiments.

FIG. 16 illustrates an example process for locking with group access policy, according to some embodiments.

FIG. 17 illustrates an example process for locking with group access policy, according to some embodiments.

FIG. 18 illustrates an example process for locking with an arbitrary Access Policy (ACL), according to some embodiments.

FIG. 19 illustrates another example process for locking with an arbitrary Access Policy (ACL), according to some embodiments.

FIG. 20 illustrates another example process for use of Proxy Re-Encryption (PRE) for delegated policy enforcement on a device, according to some embodiments.

The Figures described above are a representative set and are not an exhaustive with respect to embodying the invention.

### DESCRIPTION

Disclosed are a system, method, and article of manufacture for encoding an arbitrary access policy into data encryption. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Access-control list (ACL) is a list of permissions associated with a system resource or data object. An ACL specifies which users or system processes are granted access to objects, as well as what operations are allowed on given objects.

Application programming interface (API) can specify how software components of various systems interact with each other.

Cloud computing can involve deploying groups of remote servers and/or software networks that allow centralized data storage and online access to computer services or resources. These groups of remote servers and/or software networks can be a collection of remote computing services.

Elliptic-curve cryptography (ECC) is an approach to public-key cryptography based on the algebraic structure of elliptic curves over finite fields. ECC allows smaller keys compared to non-EC cryptography (e.g. based on plain Galois fields) to provide equivalent security. Elliptic curves are applicable for key agreement, digital signatures, pseudo-random generators, and other tasks. Indirectly, they can be used for encryption by combining the key agreement with a symmetric encryption scheme. Elliptic curves are also used in several integer factorization algorithms based on elliptic curves that have applications in cryptography, such as Lenstra elliptic curve factorization.

Elliptic-curve Diffie-Hellman (ECDH) is a key agreement protocol that allows two parties, each having an elliptic-curve public-private key pair, to establish a shared secret over an insecure channel. This shared secret may be directly used as a key, or to derive another key. The key, or the derived key, can then be used to encrypt subsequent communications using a symmetric-key cipher. It is a variant of the Diffie-Hellman protocol using elliptic-curve cryptography.

Encryption is the process of encoding information.

Facial recognition system is a technology capable of matching a human face from a digital image or a video frame against a database of faces.

Homomorphic encryption is a form of encryption that permits users to perform computations on its encrypted data without first decrypting it. These resulting computations are left in an encrypted form which, when decrypted, results in an identical output to that produced had the operations been performed on the unencrypted data. Homomorphic encryption can be used for privacy-preserving outsourced storage and computation. This allows data to be encrypted and outsourced to commercial cloud environments for processing, while encrypted.

Key can be a piece of information, usually a string of numbers or letters that are stored in a file, which, when processed through a cryptographic algorithm, can encode, or decode cryptographic data.

Key management refers to management of cryptographic keys in a cryptosystem. This includes dealing with the generation, exchange, storage, use, crypto-shredding (e.g. destruction) and replacement of keys. Key management includes cryptographic protocol design, key servers, user procedures, and other relevant protocols.

Multi Party Computation is a subfield of cryptography with the goal of creating methods for parties to jointly compute a function over their inputs while keeping those inputs private. Unlike traditional cryptographic tasks, where cryptography assures security and integrity of communication or storage and the adversary is outside the system of participants (e.g. an eavesdropper on the sender and receiver), the cryptography in this model protects participants' privacy from each other.

Non-fungible token (NFT) is a unique digital identifier that cannot be copied, substituted, or subdivided, that is recorded in a blockchain, and that is used to certify authenticity and ownership.

Proxy re-encryption (PRE) schemes can be cryptosystems which allow third parties (e.g. proxies) to alter a ciphertext which has been encrypted for one party, so that it may be decrypted by another.

Shamir's Secret Sharing (SSS) is an efficient secret sharing algorithm for distributing private information (e.g. secret) in such a way that no individual holds intelligible information about the secret. To achieve this, the secret is converted into parts (e.g. shares) from which the secret can be reassembled when a sufficient number of shares are combined but not otherwise. SSS has the unusual property of information theoretic security, meaning an adversary without enough shares cannot reconstruct the secret even with infinite time and computing capacity.

Software development kit (SDK) can be a collection of software development tools in one installable package. An SDK can facilitate the creation of applications by having a compiler, debugger and sometimes a software framework.

Trusted execution environment (TEE) is a secure area of a main processor. TEE can guarantee code and data loaded inside to be protected with respect to confidentiality and integrity. TEE can be used to provide data integrity and prevent unauthorized entities from altering data when any entity outside the TEE processes data. TEE can be used to provide code integrity such that the code in the TEE cannot be replaced or modified by unauthorized entities.

Web3 is an idea for a new iteration of the World Wide Web which incorporates concepts such as decentralization, blockchain technologies, and token-based economics.

### Example Computer Architecture and Systems

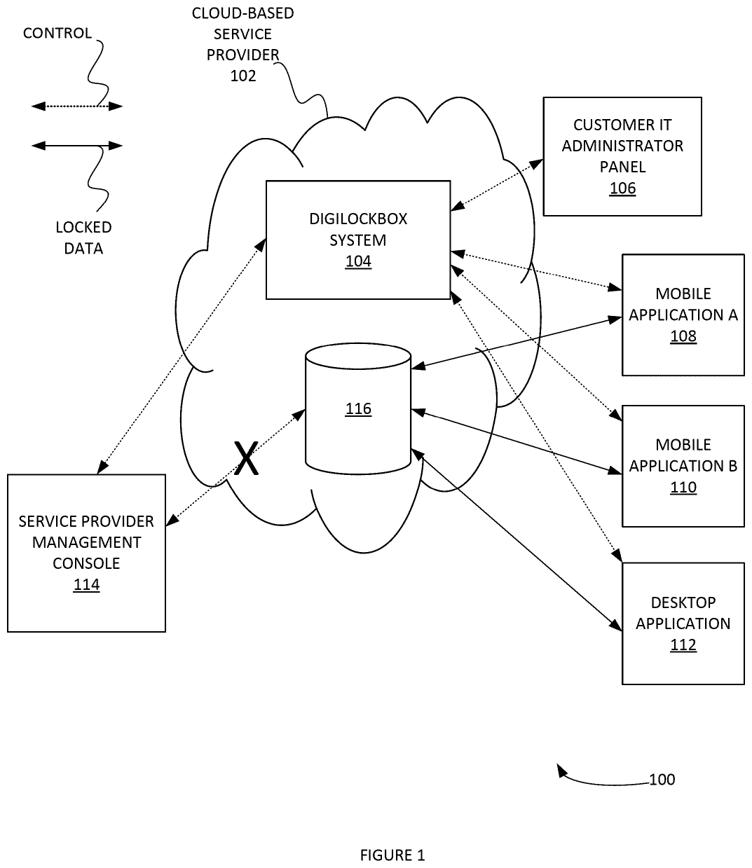

FIG. 1 illustrates an example DigiLockbox system 104 used for encoding an arbitrary access policy into data encryption, according to some embodiments.

Customer IT Administrator Panel 106 is the dashboard provided by cloud-based service 102, to its enterprise customers for management and control of the service by customer's IT administrators, including management of user permissions for customer's employee accounts, control of enterprise data, and settings etc. The necessary control settings from the IT administrators are sent to the DigiLockbox system 104 in an encrypted manner such that these settings can only be interpreted by various applications using the DigiLockbox SDK, and not by the DigiLockbox system itself.

Mobile Application A 108 is an example mobile application provided by the cloud service provider and used by some employee or contractor of the enterprise customer to interact with the cloud service, for creating and/or consuming data on behalf of the enterprise. It is integrated with DigiLockbox SDK for locking and unlocking the data for employees or contractors based on a combination of the policy provided by the application itself and the settings configured via the Customer IT Administrator Panel 106. As a result, all the data exchanged between the mobile application A 108 and the service provider Data Store 116 is always locked by pre-encoding the access policy into encryption of data.

Mobile Application B 110 is another example mobile application provided by the cloud service provider and used by some employee or contractor of the enterprise customer to interact with the cloud service, for creating and/or consuming data on behalf of the enterprise, possibly in collaboration with another mobile application A 108. It is integrated with DigiLockbox SDK for locking and unlocking the data for employees or contractors based on a combination of the policy provided by the application itself and the settings configured via the Customer IT Administrator Panel 106. As a result, all the data exchanged between the mobile application B 110 and the service provider Data Store 116 is always locked by pre-encoding the access policy into encryption of data.

Desktop Application 112 is an example of a computer application running natively on a desktop, or inside a browser, provided by the cloud service provider and used by some employee or contractor of the enterprise customer to interact with the cloud service, for creating and/or consuming data on behalf of the enterprise, possibly in collaboration with mobile application A 108, and/or mobile application B 110. It is integrated with DigiLockbox SDK for locking and unlocking the data for employees or contractors based on a combination of the policy provided by the application itself and the settings configured via the Customer IT Administrator Panel 106. As a result, all the data exchanged between the desktop application 112 and the service provider Data Store 116 is always locked by pre-encoding the access policy into encryption of data.

Data Store 116 inside the cloud service is where all the data of an enterprise customer is hosted. Typically, it is controllable by the enterprise admins via the Customer IT Admin Panel 106, as well as by certain employees of the Cloud Service Provider 102 via Service Provider Management Console 114. However after the data has been locked with access policy encoded into encryption by the DigiLockbox SDK embedded into the various applications, it is no longer accessible to any employees of the Cloud Service Provider 102.

Service Provider Management Console 114 is the admin dashboard used by IT admins of the cloud service provider itself to manage and control service for each of the enterprise customers, including data and settings. Once data has been locked/encrypted via DigiLockbox system 104, the Service Provider Management Console loses access to the customer data, and hence no employee of service-provider can access any customer data even if they have privileged admin access on the infrastructure on which the cloud service is deployed. This relinquishes the service-provider of the liability that comes with having access to customer data, especially from breaches and access by malicious insiders.

DigiLockbox system 104 provides truly generic implementation of a data encryption model with no implied trust. DigiLockbox system 104 can encode arbitrary access policies into data. DigiLockbox system 104 provides the ability to apply arbitrary fine-grained policies at the level of the data object itself, with full Enterprise Control. DigiLockbox system 104 provides context aware security policies imbedded into data encryption.

The DigiLockbox back-end software of DigiLockbox system 104 can be hosted by the application provider (e.g. together with the server of the application itself), or it can be used as an easy-to-use service hosted by DigiLockbox system 104. No matter who hosts the DigiLockbox back-end software can be agnostic as to location of hosting. DigiLockbox backend software can be designed in such a manner that no entity involved in managing it is able to access raw user data or any sensitive keys for encryption/decryption. DigiLockbox back-end software can only act as a facilitator for moving the relevant lockboxes and keys around between different users of the data on different devices. This can be done such that only encrypted content passes through the DigiLockbox server which can be decrypted only by authorized users on the end-devices they are operating on (e.g. either as end-users or as administrators). In this way, even if the entire database of the DigiLockbox server is stolen, and the contents put in the public domain without any authentication whatsoever, there is still no real harm done. The purpose of authentication and other controls enforced by the DigiLockbox server is to ensure that a flood of random requests from hackers don't cause a nuisance, thus providing an extra layer of security that is an additional benefit but not the core of the solution.

The SDK provides an easy-to-use set of functions for locking and unlocking of user-data with arbitrary policies. The SDK is designed to be easy to integrate into a new application being written from scratch, or to retrofit into an existing application with an established dataflow. There is no need to change where application data is stored, or to use any different APIs for storage of data or movement of data.

There are three (3) primary SDK functions for the application developer including, inter alia:
login ( ): This call identifies the user and establishes the context within which data objects can be subsequently locked/unlocked;
lockData ( ): This call takes clear-text data-object, and locks it with desired policies, creating a locked object. The data-object can be of the form string, file, or any binary object. The desired policies can be specified as part of the lock function itself, or they can be fetched from the server based on pre-specified configuration rules. A set of encryption-keys and lockboxes is automatically created in an appropriate hierarchy to encode the desired policy, and the data-object and lockboxes are encrypted such that only users who are part of the policy would be able to access the data. Once a locked object has been created, with policies embedded in it, it is not technically feasible to bypass the policies by anyone to access the data other than those who have genuine access as per embedded policy; and
unlockData ( ): This call takes the locked object and returns the original clear-text object that was passed to the lockData function. It is executed in context that was established earlier for the user as part of login ( ) call. The policy embedded in the locked-object is interpreted, and if the authenticated user has genuine access to the data-object, the desired set of lockboxes can be retrieved from the server (e.g. part of which could have been already pre-fetched and cached locally), decrypted locally, and eventually result in decryption of the data-object itself, returning the original clear-text object. If the authenticated-user does not have authentic access to the data-object as per its encoded policy, the local decryption can fail (e.g. even if the server is somehow fooled to release the hierarchy of lockboxes for a different user as mentioned above).

It is noted that no prior crypto knowledge is needed by the application developer. The application developer does not even need to be aware of the encryption/decryption and key-management terminology since these complicated operations are automatically handled by the SDK while converting arbitrary policies to an appropriate hierarchy of lockboxes in conjunction with DigiLockbox's back-end server.

If DigiLockbox SDK is used to lock the data as soon as it is created and unlock it only when it needs to be presented to the user, the data stays encrypted from cradle to grave, or end-to-end in a true sense of the phrase.

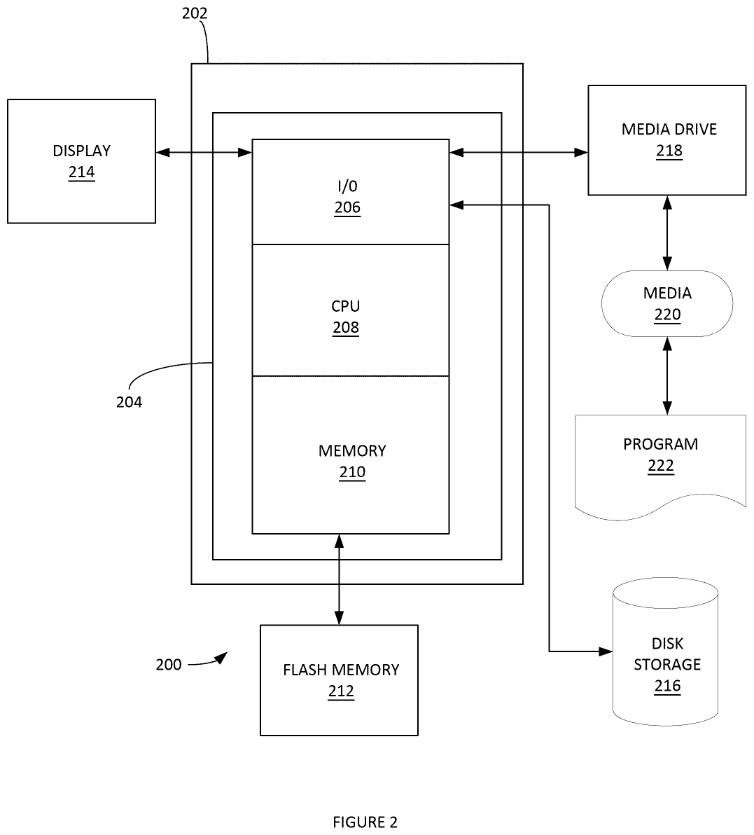

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or various aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

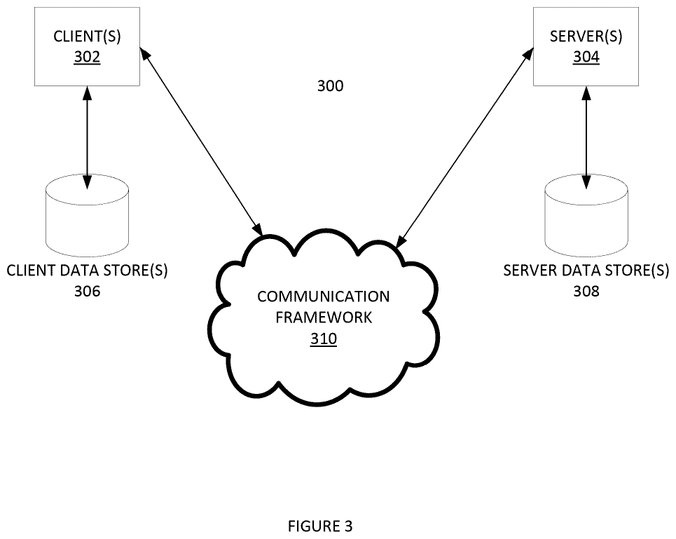

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### EXAMPLE METHODS

Various methods are now discussed.

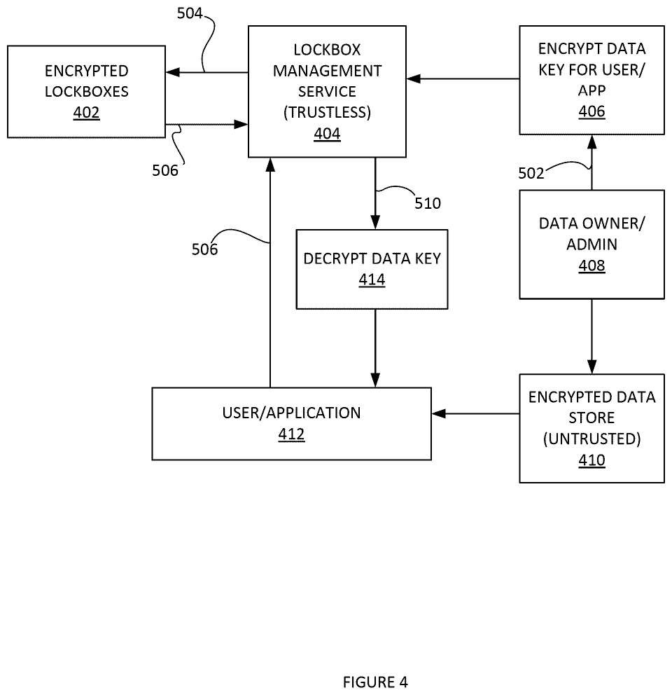

FIG. 4 illustrates an example DigiLockbox system 400, according to some embodiments. DigiLockbox process 400 system can be used to implement DigiLockbox process 500 provided infra.

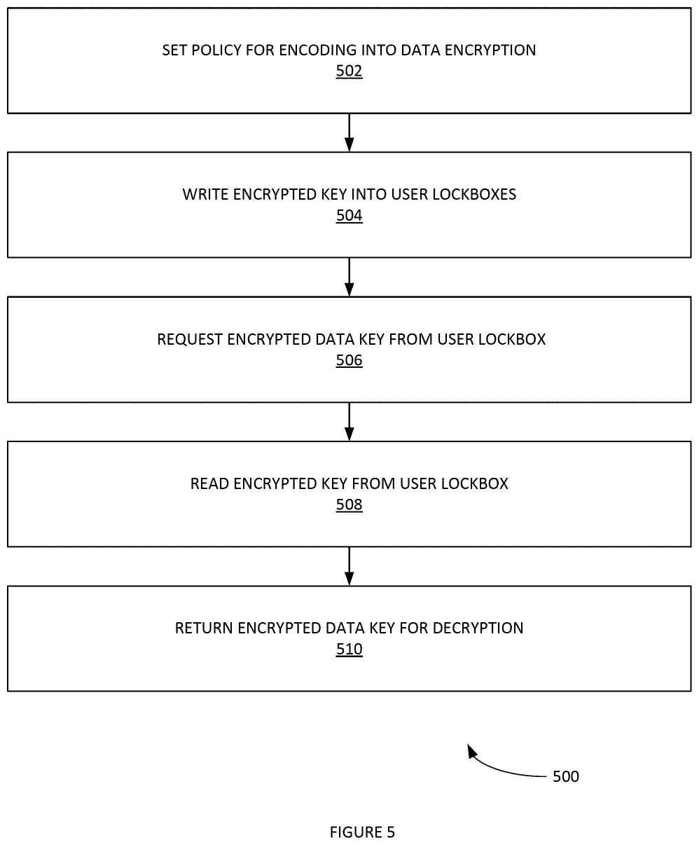

FIG. 5 illustrates an example DigiLockbox process 500, according to some embodiments. When a user encrypts an object and shares it with other users via some access policy (e.g. see step 502), the DigiLockbox process 500 generates the encryption key and securely placing the key inside both the sending and receiving users' lockboxes.

As part of process 500, the DigiLockbox system creates a locked object, with desired access policies embedded into the encryption, such that these policies stay with the locked object no matter where it goes. When the receiving user receives this locked object, they access the data by invoking the same software that they normally use. However, while using the DigiLockbox system, the software attempts to obtain the encryption key from the lockbox of the receiving user (e.g. step 506) rather than the traditional centralized database of keys inside, or that controlled by, the trusted data store. This attempt, in turn, triggers a notification to the receiving user-who is the owner of the lockbox in this case. The lockbox owner is required to open the lockbox with their own set of passwords if they want the software to decrypt the locked object. After the lockbox is opened, only if the decryption key for that particular object is available in the receiving user's lockbox, this software will be able to decrypt the object for that user (e.g. step 510).

Process 500 removes the two big vulnerabilities present in traditional systems. There is no centralized database of encryption keys with central policy control, and system administrators do not have access to the users' encryption keys. As a result, even if the underlying software or computer system is compromised, hackers cannot access the data as they cannot open a user's lockbox without the correct combination of user passwords.

The use of a DigiLockbox is transparent to the end-user, provided the software application developer routes data access through the DigiLockbox SDK. The SDK manages the placement of keys in user lockboxes and encryption/decryption of data. The SDK manages all data encryption keys, and cryptographic operations on them using symmetric/asymmetric cryptograpy, after integration into an application.

More specifically, in step 502 process 500 can set an access policy for encoding into data encryption by the data owner or admin. After encrypting the data key for appropriate user or application, in step 504, process 500 can write the encrypted key into appropriate user lockboxes. In step 508, process 500 can request user key from lockbox as an attempt is made to access the data inside the application for presenting to the user. In step 506, process 500 can read the encrypted key from user lockbox. In step 510, process 500 can return the encrypted key retrieved from user lockbox for the final decryption operations inside the SDK integrated into the application.

Encrypted lockboxes 402 provided storage for encrypted lockboxes belonging to each user. Encrypted lockboxes 402 receives/implements step 504 for storage and outputs/implements step 506. Lockbox management service (e.g. trustless) 404 implements the lockbox management service. Lockbox management service 404 receives step 508 for retrieving a key from user's lockbox and outputs step 510. Lockbox management service 404 receives/implements step 506 and outputs/implements step 504.

User/application 412 implements step 508. Decrypt data key 414 receives step 510 and provides data key to user/application 412 after decryption. Data owner/administrator 408 implements step 502 to encrypt data key for user/application 406. Encrypted data store (untrusted) 410 does not implement any special steps of process 500 as it is used in the traditional manner to store encrypted data provided by the data owner, which is passed as-is to the user/application for decryption/processing.

### Risk-Aware Lockboxes

Risk-aware lockboxes are now discussed. It is noted that context awareness can be built into the access-policies. These can be enforced by DigiLockbox SDK every time any piece of data is accessed. This can occur even if it has already been downloaded and cached locally on the device. Potentially suspicious access by even an authorized user to secure data can also be immediately (e.g. assuming networking, processing, and/or other system latencies, etc.) detected, and double-checked for validity.

In one example of contextual policy enforcement with a risk-aware lockbox (e.g. implemented by a DigiLockbox, etc.) an employee with access to sensitive information travels to China and is forced to unlock his phone or computer by local authorities, the employee's DigiLockbox can detect the new location and force additional authorization and/or approval by a security administrator of the company before allowing unlocking of any data, even if the data is already residing locally on the end device.

In another example of contextual policy enforcement with a risk-aware lockbox example of contextual policies is that of a nurse, where the risk-aware lockbox policies can allow unrestricted access to any patient data on his or her mobile device while within the hospital building and within normal working hours but require additional authorization outside the norm. If the nurse attempts to access patient data while sitting in a coffee shop late at night because of some emergency, the system can prompt for 2nd factor authorization, and/or require approval from a superior to ensure that privacy of a patient is not compromised because of an over-curious hospital employee, and yet emergency situations out of the norm can be handled practically and conveniently. This can be implemented by risk-aware lockbox module.

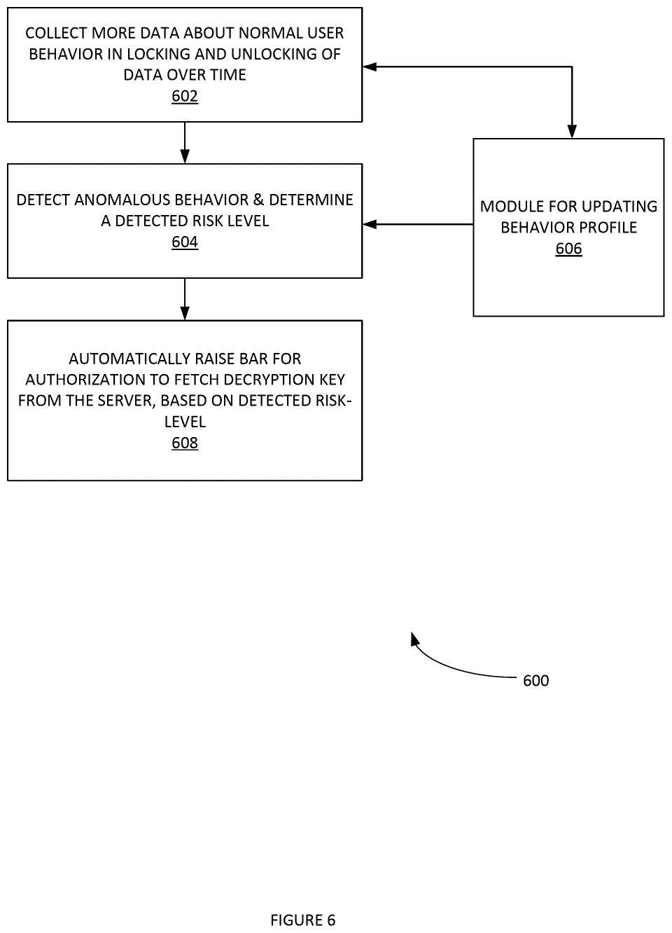

FIG. 6 illustrates an example risk-aware lockbox process 600, according to some embodiments. Process 600 enables risk-aware lockbox module 608 to collect more data about normal user behavior in locking and unlocking of data over time. The risk-aware lockbox module 608 can become smarter (e.g. more optimized using Al/ML optimization techniques, etc.) about detecting anomalous behavior, and automatically raise the bar for authorization to fetch the decryption key from the server, based on detected risk-level. The higher level of authorization can include requiring a second or third factor from the user, or it could involve authorization from another entity in the enterprise (e.g. by either a superior or a security admin). The risk-aware lockbox module 608 can adjust the lease period of keys automatically based on the detected risk-profile of the user and risk-level of the current situation. Risk-aware lockbox module 608 can manage who haves access to what data where and when, rather than trying to protect something around the data.

More specifically, in step 602, process 600 can collect more data about normal user behavior in locking and unlocking of data over a specified period of time. In step 604, process 600 can detect anomalous behavior and determine a detected risk level. In step 608, process 600 can automatically raise the bar for authorization to fetch decryption key from the server, based on detected risk-level. Process 600 can include and leverage a module for updating behavior profile 606.

### Example Ease of Use/Integration Methods

In some embodiments, the DigiLockbox can provide an easy and convenient service to use for embedding data security and privacy into any application. This can be a brand-new application developed from scratch and/or an existing application that requires data protection to be retrofitted after the fact. For a new developer to use DigiLockbox, they just need to learn a few new primary lines of code with no prior knowledge of cryptography.

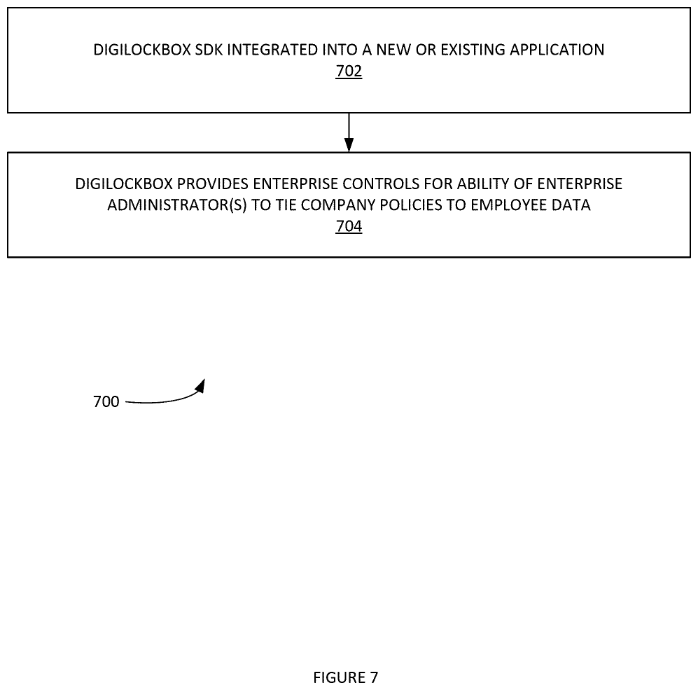

FIG. 7 illustrates an example DigiLockbox SDK process 700, according to some embodiments. In step 702, a DigiLockbox SDK can be integrated into any new or existing application with only days of development effort, with no change in user-experience or degradation of performance from a computer or network perspective. In step 704, for enterprise applications, process 700 use the DigiLockbox to provide enterprise controls for the ability of enterprise administrators to tie company policies to employee data. Thus, DigiLockbox can form the basis of universal privacy for the applications in the long term for any use-case.

### True End-to-End Encryption Example

Since end-to-end encryption is a commonly used term or phrase, especially in context of messaging apps such as WhatsApp, Signal, Wickr, etc. A DigiLockbox service takes that model even further.

It is noted that most of the messaging apps that use so-called end-to-end encryption actually use device-to-device encryption to protect user data only while in transit, where the outbound data provided is locked with the right policy of the recipient device at the time of leaving sender's device. It can be unlocked on entering the recipient's device. The locally stored data on both the sender's device as well as the recipient's device uses a different set of encryption keys (e.g. if it is kept encrypted at all), and not necessarily secured using the same technique that is used for encrypting in-transit data. As a result, it is much easier for a hacker to steal the locally stored data, or a backup copy of it if it is being backed-up. Indeed, WhatsApp data itself is backed-up to iCloud for iOS devices and to Google Drive for Android devices, and this data is not protected by the same end-to-end encryption that is used for protecting the in-transit data, even though this is something that Facebook is in the process of fixing right now. So practically speaking, till recently before the issue was fixed, it would have been easier for a hacker (or a malicious insider, or even a government agency) to have access to millions of users' WhatsApp accounts by breaking into iCloud or Google-Drive servers rather than breaking into WhatsApp's own servers.

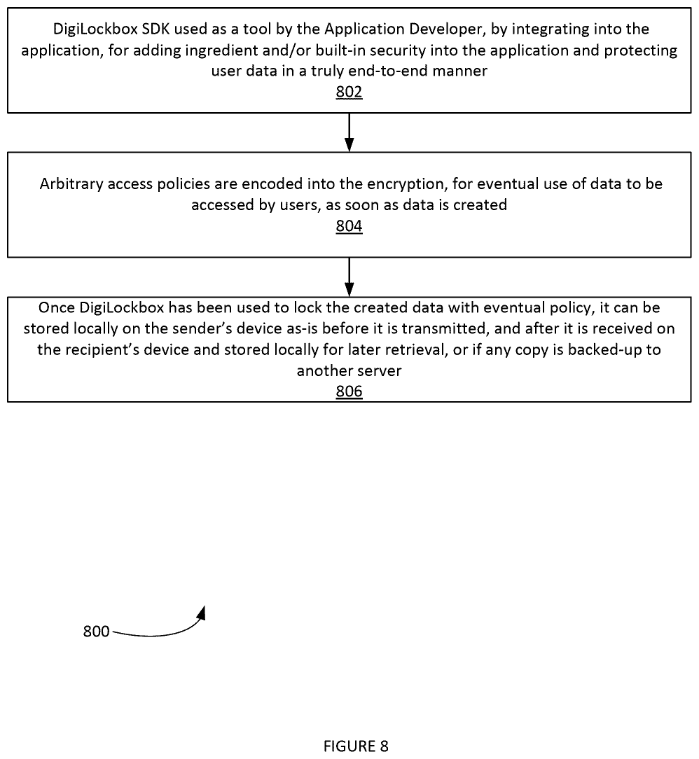

FIG. 8 illustrates an example process 800 of a DigiLockbox solution, according to some embodiments. In step 802, process 800 provides the best tool available to any application developer for adding ingredients or built-in security into the application for protecting user data in a truly end-to-end manner. It provides a similar convenient service for adding data-protection into any new or existing application, as provided by Twilio for adding messaging functionality into an application.

In step 806, process 800 provides true user-to-user encryption instead, because with the DigiLockbox, the data stays locked with same policy even before it leaves the sender's device, and even after it is received on the recipient device and stored locally for later retrieval, or if any copy is backed-up to some other server. Process 800 can enable this true end-to-end encryption because of its ability to encode arbitrary access policies into the encryption itself, thus allowing data to have encrypted with eventual policy as soon as it is created in step 804 (e.g. rather than using one policy for local storage of data vs another policy for transmitting the data over the network).

### Example Saas Provider Use Case

While the DigiLockbox is broadly applicable to any type of software accessing any data, it is especially suitable for SaaS software. Since security policies can be completely arbitrary, a SaaS service provider (e.g. can be cloud-based service provider 102) can attach policies to customer data such that even the service provider itself cannot access the data. The DigiLockbox solution provided herein enables the service to become a zero-visibility and zero-liability bank for customer data. The DigiLockbox solution can provide the best data security available out there and avoid the cost and legal liability of a data breach. Further, the DigiLockbox solution can provide enterprise-grade control for the service provider's customers with an automatically created administrator panel. This also gives a clear advantage over the service provider's competitors.

In one example, using DigiLockbox, a credit-agency can continue to act as an intermediary and be the custodian of consumers' credit-files, and continue to consolidate information from different creditors and provide limited access to a relevant party (e.g. a lender), yet keep it stored so that even the credit agency cannot access a consumer's credit-file without the owner giving explicit authorization. Accordingly, the consumer always stays in full control of their private data, including the ability to revoke access for anyone in certain scenarios. In the enterprise use-case, if the customer of the SaaS service provider happens to be an enterprise rather than an individual consumer, then the enterprise can enforce its own policies to ensure the company doesn't lose data when the service provider has a breach, or even in case the employee creating or using the data quits or is incapacitated. There may be no technical way to bypass these policies, even by a malicious trusted administrator or hacked/buggy software, because these access policies are tied into the encryption itself. As a result, these Keychain-like lockboxes, with arbitrary ACLs (Access Control Lists) embedded in them, provide policy enforcement on data access without requiring trust in any software or human, enabling a true Trustless environment where data can actually be anywhere and everywhere without any boundaries.

The SaaS services provided herein can behave as a digital bank locker. SaaS can be a delivery model for most of the enterprise applications today, with increasing use of PaaS and IaaS infrastructure in the cloud for building these apps. When an enterprise customer trusts these SaaS apps with their data, the digital gold of today, these apps, and the underlying cloud infrastructure, are acting as banks of the modern world-keeping that enterprise's digital assets in their safe custody for use by enterprise's employees and partners.

The SaaS cloud services provided herein can be used to control a digital asset for specified sensitive or high-value assets. The DigiLockbox systems and methods provide a simple mechanism using which the developers of such enterprise applications, built on top of any cloud service, can not only keep the data safe and under control while allowing safe access through partner APIs.

### Decentralized Web3/Blockchain Use Cases

Blockchain, and the accompanying web3 decentralized infrastructure, by definition can provide a “trustless” mechanism for storage of public information only (with full transparency). However, for many real-life use-cases, besides the data-integrity provided by blockchain, a mechanism can be used to protect the confidentiality of any private user content that can't be made public, and make sure content owners themselves stay in control of their private data (e.g. without having to rely on a trusted “centralized” service, which would otherwise defeat the whole purpose of decentralization).

DigiLockbox can be a simple mechanism that can enable developers of web3 applications to not only secure their user's crypto wallets easily, but also enforce arbitrary access controls on user data without having to rely on any trusted centralized services. In this way, opening-up use of NFTs and web3 to some serious use-cases and realize its true potential.

### Confidential Compute Use Case

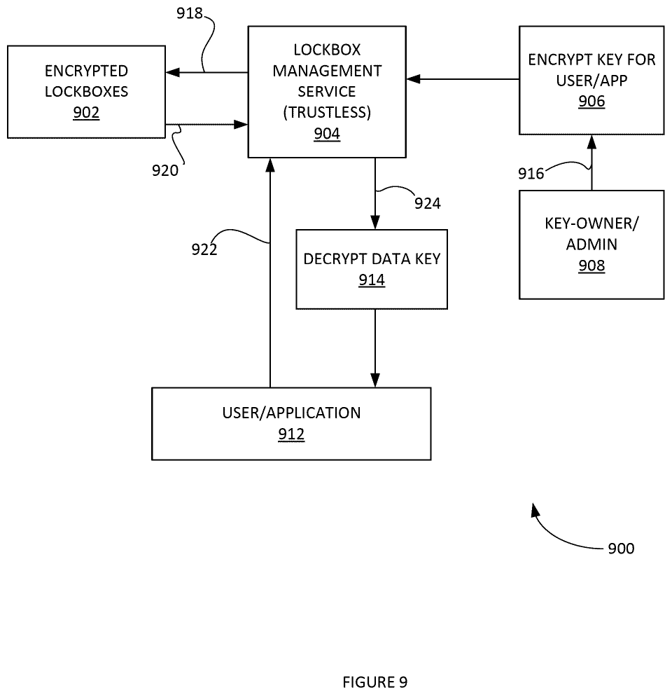

FIG. 9 illustrates an example process 900 for key management, according to some embodiments. DigiLockbox can be used for keeping the decryption keys for confidential computing, such that there is no need to rely on any centralized service for key-management or for user authentication, as depicted in the picture. This can be an extension of the DigiLockbox inherent general-purpose policy-encoding logic. Just like a generic policy can be encoded in a trustless model to allow other users, groups, entities, applications, etc. to access the underlying data through decentralized key-management, authorized access by a TEE code can be easily added into the same policy. The decryption key is shared by the data owner directly with authorized code, without relying on a central trusted service for key storage or for user authentication, as the keys are themselves shared by re-encoding them in a decentralized manner. With this model, no trusted administrator, either for the key-vault or for the authentication service, can have access to any decryption keys, and hence the entire system becomes completely trustless with only the data owners having exclusive control over their data, not just for confidential compute specific use-cases that are meant to protect data in use, but even for the generic use-cases, irrespective of where data is kept or processed.

More specifically, process 900 can entail setting of policy 916 by the Key-owner/administrator 908 to control access to the specific key by a designated user/application 912. The policy can be encoded into encryption of the key by the encrypt key function 906, and the encrypted keys are passed to the lockbox management service (e.g. trustless) 904. The encrypted key(s) is written by the lockbox management service (trustless) to encrypted lockbox(es) 902 of appropriate users via 918. This encrypted key will be later read via 920 when a request comes from any user to access the key in their lockbox. When a user/application 912 tries to use some key that it should have access to, it makes a request to the lockbox management service 904 in order to retrieve this encrypted key from its lockbox via 922. The lockbox management service 904 reads the encrypted user/application key 920 from the encrypted lockboxes 902 and returns the encrypted key 924 to the application for decryption by Decrypt Data Key 914 via DigiLockbox SDK embedded inside the application. The decrypted key is finally passed to the user/application 912 for its use without any intermediate entity in the middle getting access to the key, as is usually the case with traditional systems.

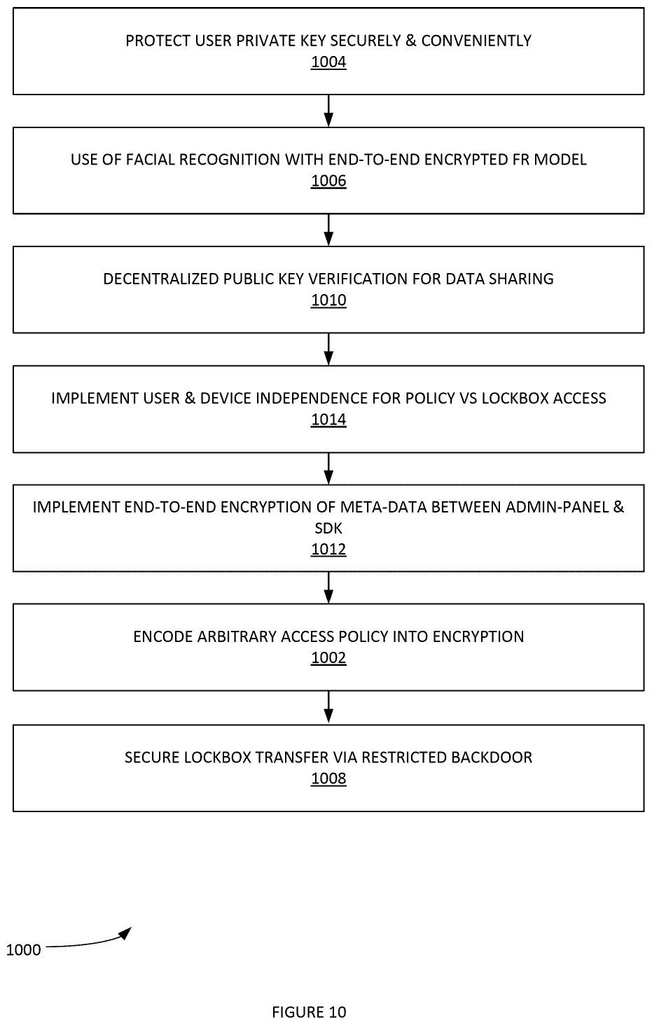

FIG. 10 illustrates an example process 1000 for data encryption and privacy, according to some embodiments. In step 1002, process 1000 can encode arbitrary access policy into encryption.

Process 1000 can be used for encoding arbitrary access control Lists through a hierarchy of lockboxes created with a combination of symmetric and asymmetric cryptographic techniques, with the desirable property of being able to change the policy without touching the data-objects it applies to.

Process 1000 can be used for creating and enforcing arbitrary authorization policies on data objects without having to rely on any trusted servers, including for validation of user identities. Process 1000 can provide an end-to-end encryption mechanism available to enable an access policy with an arbitrary list of users, entities, and groups-something that is necessary for general-purpose use-cases.

If the same authorization policy is applied to multiple data objects, every individual data object should still be encrypted with a different key. It can also be possible to change the policy without having to re-encrypt, or even touch any data objects, yet the new updated policy should still be automatically enforced on the relevant objects to which it applies.

Process 1000 can be used to detect and prevent harm even if the authoritarian servers of an application (e.g. authentication layer or authorization code inside the application) and other systems they rely on (e.g. email/SMS services for OTP delivery) have been taken over by a malicious entity (e.g. rogue state sponsored intrusion).

The DigiLockbox enables these requirements by creating a hierarchy of lockboxes to encode an encryption policy. Each policy haves its own unique base encryption key, from which the data object keys are derived. The base key of the policy is itself encrypted with the key to every user and group that is authorized to access the data encoded with this policy. The key to each group itself is then further encrypted with the public key of every member that belongs to that group.

And by using a separate key for encryption vs signature generation/validation, different types of read and/or write access can be enforced. While some entities with just the decryption key can have read-only access to the data object, other entities with both the decryption key and signature key can have read-write access. And an entity with just the signature key and only access to public key of the object policy for writing, can have asymmetric write-only access where it cannot access the data anymore after it has been locked.

The DigiLockbox can include a generic locking mechanism that can be used to lock keys or secrets instead of locking the data itself. In this way, the DigiLockbox can act as an easy replacement for various key-vaults or key management services where secrets or keys are not kept centrally with control of administrators and are instead managed in a decentralized manner under control of the users or secret-owners.

Through this decentralized control of all encryption keys where every key in the Keystore is of different color, as per the corresponding color of the user who controls that key, process 1000 can ensure that users stay in exclusive control of all their data (or keys when being used in a key-vault), with no centralized authentication or authorization service having any access to user data (or keys). This is in sharp contrast to the traditional model shown, where all the keys in the Keystore are controlled by the central Authorization Service, and hence the same color grey—the corresponding color of the authorization service itself. The traditional model has lots of vulnerabilities at many different levels due to reliance on centralized authentication service as well as authorization service, which process 1000 can ensure that the DigiLockbox system becomes completely immune to.

The resulting solution can be used by developers of both centralized/Web2.0 applications and even decentralized/Web3.0 apps so that they can enable secure private-sharing of data and make their systems virtually hack-proof and breach-resistant against most of the modern cyber-threats. This solution for arbitrary access policies can be further enhanced for solving some of the following problems that are applicable to even broader use-cases:

Process 1000 can provide temporary access for some data and revoking it either manually or automatically based on a timed grant.

Process 1000 can provide interoperation and integration with other useful encryption techniques like homomorphic encryption, and confidential compute to enable server-side processing of data. Both these techniques are very complementary to a generic model of encrypting data on the client side with desired policies, which can be expanded to include these methodologies in appropriate use-cases. For example, locking the data using two different encryption keys, one with stronger security for permanent storage, and one for homomorphic computation by server, or conducting the integrity check on code to be executed in TEE before releasing the decryption key for confidential computation on the server.

Process 1000 can protect user private key securely and conveniently. For example, process 1000 can provide a system and method of generating a strong envelope around user's private key, to protect it from brute-force attacks, by using Shamir's Secret Sharing (SSS) technique on multitude of easy-to-remember passwords, with each one being possibly weak on its own, effectively creating the security of a strong password.

Process 1000 can use the cryptographic technique of Shamir's Secret Sharing (SSS) to create a complicated and strong secret by combining a multitude of simpler, and possibly weak secrets, to protect the user account. Since this technique uses N total secrets chosen by the user, out of which at least K have to be correct to generate the original combined secret, the user can choose simple and easy to remember passwords for each one of the N secrets. Since the final secret needed to decrypt user's key is a combination of these N secrets, it will automatically generate a complex and strong secret for the user even if the individual passwords are themselves weak. It is noted that the cryptographic technique of SSS is well known and typically used to split a single secret across multiple people such that a single person cannot retrieve the original secret on their own. In one example case, process 1000 can have taken it and applied it in a unique non-obvious way to split user's primary secret across a multitude of simple, and easy to remember, passwords owned by the same user, which simulates the generation of a complex and strong password. The user also has some leeway in the sense that even if they forget up to (N-K) passwords, they can still access their account. For the hacker, it will still be more difficult to guess K different passwords especially considering that nobody knows which of the K passwords entered by the user are correct when they login, or even how many of them are correct, as long as at least K are indeed correct. This keeps control of the user's account completely in their own hands, without relying on a single password and, more importantly, without having to trust any centralized service.

The attached screenshots show the scenario where user is being asked to choose 5 different passwords (so N=5), out of which at least 3 will need to be correct (so K=3) for a fresh login from a new device.

It is noted that in another variation, instead of presenting the five (5) questions to the user at the time of login and asking them to enter answers to of them with at least three (3) answers needing to be correct, the user could be presented with three (3) (or even 4) randomly selected questions out of a total available of five (5).

And in yet another most generic variation, the user could decide on their own what values of N and K they want to choose. Some users could even choose K=N when they are sure that they will not forget anything.

And in another variation, to give less choice to the user, the application could offer a standard set of questions to the user to choose from (e.g. via a dropdown list) instead of allowing them to enter a completely freeform input field for each question.

Process 1000 can make use of Facial Recognition with end-to-end Encrypted FR Model. Process 1000 can use a phishing-resistant 2^{nd} factor while the user is trying to login from a new device and an existing device is not available. Facial Recognition on the server-side is the easiest and most-convenient phishing-resistant technique available for this, as most devices these days already have a built-in camera (even if not, a special one-time-use magic-link can be sent to user's phone-number or email address for verification of their face-ID from another device that does have a camera). The usual concern with use of facial-recognition on the server-side like this is the potential privacy issues with storing the face-model of users on a trusted server. Even though the actual image of the user's face is not stored on the server, and only a model/fingerprint generated from the facial image is stored, this model is still highly personal information for the user. There can be a risk with leakage of this personal information if the server is compromised/breached. In order to address this privacy concern, the DigiLockbox technology can be used on the FR-model itself so that the server is not able to access the face-model without user's permission. This recursive use of DigiLockbox ensures that even if the DigiLockbox server keeping FR-models is compromised, no personal data of users is at risk considering that even these FR-models are kept encrypted with user-specific encryption key. In order for a hacker to even have access to the user's face-model, they will have to break into not just the server storing these FR-models, but also break into user's multitude of passwords through a phishing attack. Even after having access to a single user's face-model through this process (every user's face-model is kept encrypted with a different user-specific key), the hacker still can't have access to the user's lockbox because the server will still need to match user's face against the model that it knows. This model provides the best protection against even the phishing attacks, without compromising on user's personal information even in the event of a server breach.

Process 1000 can use a secure lockbox transfer via a restricted backdoor. For the enterprises, one of the big concerns with giving control directly to employees in a decentralized manner, like what DigiLockbox enables, is that the employer itself could end up losing control of some data in certain situations. In an example enterprise situation, a company is the true owner of the data, and employees, contractors, partners, etc. are just acting on behalf of the employer as they create the data or use it for the benefit of the company. In such a situation, the enterprise cannot afford to lose access to the data, or even control over it, if some employee(s) leaves abruptly without voluntarily transferring control of the data back to the company (e.g. either employee becomes disgruntled/malicious, or they are hit by a bus). The company needs sufficient protection in this case to ensure that the enterprise data that was under exclusive control of the departed employee can be safely transferred to another employee of the company in the rare event that the employee is no longer available to voluntarily relinquish control back to the company.

Since process 1000 is closing any backdoor by using an end-to-end encryption model with decentralized control, process 1000 can re-introduce a small backdoor to be used in exceptional cases. Since it will be used in rare emergency type situations only, it is okay for the backdoor to be somewhat cumbersome to use in order to maintain the overall security of the entire system.

Process 1000 can create a backdoor controlled by multiple administrator users of the company (e.g. N) without trusting any single central service or point in the entire system. This can be such that a high-security transaction is executed for every such use of the backdoor, with full transparency in front of An authorized administrators out of which at least K need to provide approval, and any one of the N administrators can veto to cancel the transaction at any point before it is fully executed. Even after full authorization from at least K administrators, the transfer of enterprise owned data (e.g. via specific employee key) is done to a designated target employee of the company who needs to accept the data of departed employee, and not any of the authorizing administrators. Also the N authorized administrators can even be put under different administrative controls, so that not only at least K administrators need to collude to access the backdoor, these administrators are not under same control hierarchy either and/or even then the data itself is never transferred to any of them. Even more importantly, the backdoor for an enterprise will only be able to transfer the employee-specific key of the departed user which controls user-data owned only by that enterprise. Accordingly, if the user were involved with multiple organizations in different capacities, either as an employee, or as a contractor, partner etc., each organization will have a different employee-key designated for use by the same user. So even the same application could maintain different employee-specific keys for the same user for managing the data under different user accounts. For example, the same user could be using Gmail application on their phone, and they could have multiple accounts on behalf of different employers, and also a personal gmail.com account for their individual use. The user itself will have a single user-key for the Gmail application being used in this case, but every account will have its own separate employee-key specific to the employer who owns that account, and user-data is controlled by the employee-specific key. The employee-specific keys of the user are made available to respective backdoors of each organization after consent from the user before they are allowed to access company's data, and the employee-key of the user's personal account is not made available to any organizational backdoor and kept under control of the individual user-key itself.

For achieving this scheme, process 1000 can use another cryptographic technique called Multi Party Computation (MPC). This can be a more general version of SSS technique that enables the backdoor to be split into N users, such that at least K users need to execute their authorization through threshold signatures (e.g. at least a threshold of signatures needs to be obtained) in order to unlock the backdoor. Once again, the cryptographic technique is generic and typically used to execute high-security transactions requiring multiple authorizations. Process 1000 can take this generic technique and uniquely combine it with the element of transparency and employee-specific private keys for each user (e.g. if a user is acting on behalf of multiple organizations, they will have a separate private-key for each organization) to enable an enterprise-level backdoor in a secure way.

In one example, process 1000 can maintain three (3) tables to maintain the state for a complete transaction. The table can include an ApprovalTransaction value. The ApprovalTransaction value can include the information of a transaction including label, status, minimum approval count, source, target, initiator.

The table can include an ApprovalTransacrionKeyDetail value. The ApprovalTransacrionKeyDetail value has the securityAdmin's employeePublicKey encrypted transaction EncryptionKey for the security admins of a company. When the Security Admins (e.g. minimumApprovals) have given the approval then it contains the sourceEmployeePrivateKey (e.g. decrypted with the SecurityAdminPrivateKey/BackdoorPrivateKey) encrypted with the targetEmployeePublicKey. When the securityAdmins (e.g. minimumApprovals) have given the approval then the securityAdmin's employeePublicKey encrypted transactionEncryptionKeys can be deleted.

The table can include an ApprovalTransactionDetail value. The ApprovalTransactionDetail value has the backdoorPrivateKeyPart of the securityAdmins who have approved the transaction. When the transaction is accepted or declined then it can be added as a new row in this table with backdoorPrivateKeyPart as null. The purpose of this is to check the time when the transaction was accepted or declined.

Transaction flow methods are now discussed. In an initiate step, a new transactionEncrptionKey can be created. This transactionEncrptionKey can be used to encrypt and decrypt the backdoorPrivateKeyPart. The transactionEncrptionKey can be encrypted with the securityAdmins' employeePublicKey of a company and it is kept in ApprovalTransacrionKeyDetail.

A new object of ApprovalTransaction is created and it contains label, status, minimumApprovalCount, initiator, source, target, and this is saved in ApprovalTransaction. Upon approval, when a secuirtyAdmin comes to approve the transaction then the securityAdmin's employeePublicKey encrypted transactionEncrptionKey can be retrieved from approvalTransacrionKeyDetail. This transactionEncrptionKey can be decrypted with securityAdmin's employeePrivateKey. The backdoorPrivateKeyPart of this securityAdmin with employeePrivateKey can be decrypted. The decrptedBackdoorPrivateKeyPart is encrypted with decryptedTransactionEncrptionKey and it will be saved in ApprovalTransactionDetail.

If the minimum approvals required are complete for a transaction, then the last approving security administrator has the backdoorPrivateKeyPart from ApprovalTransactionDetail for this transaction. These can decrypt the backdoorPrivateKeyPart with transactionEncryptionKey and combine these backdoorPrivateKeyParts with SSS. They take out the sourceEmployee's privateKey which is encrypted with backdoorPublickey from adminEmployeeLockBox. Using this combined backdoorPrivateKeys, the sourceEmployee's privateKey is decrypted. This source employee privateKey can be encrypted with the target employee publicKey and it can be saved in ApprovalTransactionKeyDetail. The LMS can update the transactionStatus as approved in ApprovalTransaction. The LMS deletes the securityAdminPublicKey encrypted transactionKey from the ApprovalTransactionKeyDetail. The LMS updates the transactionStatus has declined in ApprovalTransaction. The LMS adds a new row in ApprovalTransactionDetail with backdoorPrivateKeyPart as null, the purpose of this is to have the time and details of the security admin who has declined the transaction. It is noted that any security administrator can decline a transaction even after approving it and once a transaction is declined then it is completely stopped.

Another potential use of such a secure backdoor is for individual account recovery in consumer use-cases, where the backdoor for every user could be controlled by a different set of N designated “nominees” instead of same N administrators controlling the enterprise backdoor of an entire organization. In this case, a user themselves could choose N nominees, who they want to designate for securely recovering their account in case they themselves have locked out or incapacitated, such that at least K nominees need to authorize the account recovery. This mechanism can also be used to securely pass on the digital estate assets of the user to the next of the kin in case of their death.

Process 1000 can utilize decentralized public key verification for data sharing. Process 1000 can detect and prevent harm even if the authoritarian servers of an application (e.g. authentication layer or authorization code inside the application) and other systems they rely on (e.g. email/SMS services for OTP delivery) have been taken over by a malicious entity (e.g. rogue state sponsored intrusion).

The DigiLockbox system has incorporated an identity verification system, which works in conjunction with several other public and private systems, for users or enterprise-administrators to be able to themselves configure and specify what kind and level of user identity verification they are willing to trust from different available sources, for any strangers (e.g. who they have never communicated with earlier). It then gives them an indication of the current validation level (e.g. in different bands of red, yellow, green, etc.) at which each user's identity has been verified before they decide to trust them. The validation level of a user's identity can also move up over time, as it has been verified by more independent sources. This model also emulates the real-life situation where the trust in some person or entity can increase over time as more trusted people are found. When some good public, and possibly decentralized, identity verification systems become mature and widespread, these can become default policies for most users/enterprises to use, thus allowing the system to automatically evolve with change in situation.

Different independent sources of identity verification can be used in combination by any user or enterprise-administrator to configure which sources they are willing to trust for a stranger. Once a trust relationship has been established for a user with another entity, that entity is not considered stranger for that user anymore. Their public key is self-signed by the user, along with the source that was used to validate the identity of the entity, so that it can be reused by the user even on a different device without having to establish trust with same entity again. The only reason to reestablish trust would be in case the public key of the entity changes for some reason, and in that case the system starts treating the new identity of the entity as a stranger again, having to go through the same policy of establishing trust from scratch. The DigiLockbox system uses user or entity specific public keys that are managed independently of device-keys, which makes it extremely rare for a public key of a user or an entity to change. Note that even though the following sources are roughly in order of increasing trust level, the actual trust level for each user would be governed by policy configured for them (either by themselves or by their employer).

Process 1000 can provide a trusted service from the service-provider. This is the easiest source of trust, as the service-provider could easily provide a centralized database of public-keys to be used by its users irrespective of what identity provider is being used by each customer enterprise, and whether the identity service provides a mechanism to maintain and validate public keys.

Process 1000 can provide a trusted identity server under control of the enterprise. This model haves rid of trust in the service provider, but it shifts the burden of trust to the identity-provider chosen by the enterprise. Even though it helps a little bit in the sense that the service-provider itself is no longer vulnerable, now the vulnerability shifts to the identity-providers instead.

Process 1000 can provide a trusted administrator-approval of the enterprise. This model allows an enterprise-administrator to explicitly attest public-keys of the company's employees while approving them for onboarding, and this can be done without trusting any centralized service. Accordingly, the public key of the employee being onboarded is signed directly by a key under control of the enterprise-administrator, where this enterprise administrator key is not available to any centralized service. This may do away with trust in any centralized server, as only specific administrators or administrator-controlled keys are trusted by the system. This works pretty well for employees of the same enterprise but is a bit challenging to scale for cross-company collaboration in an environment where many different companies are involved, with different administrators controlling and certifying public keys of different company's employees. In this case, a combination of this technique with another source has to be used in order to establish trust in the administrator keys of other companies, which can then be used to establish trust in employees of those companies.

Process 1000 can provide key transparency and/or the equivalent thereof. A public or private key-discovery service with tamper-proof mechanism to ensure that the public-key of a user being looked-up has not been compromised. Key transparency can provide a public and auditable log of changes in the public key of any user being looked-up. An enterprise or a user might be willing to trust one or more of such services, which can be configured as policy in the DigiLockbox SDK so the public keys of strangers can be pulled-in from one or more of such sources, if available, to establish trust. Considering that these databases are still rather sparse, so if none of the such trusted sources have the public key of the user being looked-up (e.g. or if the user/enterprise is not willing to trust any of such sources despite their tamper-proof nature), process 1000 can utilize other sources instead.

Process 1000 can provide blockchain based decentralized identity. There are efforts in place to create a completely decentralized identity management system on top of blockchain, with users themselves in full control of their identity. The use of blockchain ensures that no centralized service must be trusted to even maintain an auditable log, so even if one or more service-provider(s) of some node(s) in blockchain goes down, the service still stays operational. The decentralized nature and immutability of blockchain technically ensures that the keys are indeed tamper-proof. However, such services are still in their infancy, and mostly targeting consumer use cases rather than enterprise use-cases. As and when these services evolve, DigiLockbox can incorporate them and make them available to users and enterprises as a configurable source of public keys to establish trust.

Process 1000 can bridge trust via other trusted sources. In real life, in certain scenarios, certificates from some known central authorities can be trusted (e.g. such as ID-cards or other documents issued by government authorities). But in other scenarios, process 1000 can rely on other people process 100 has already trusted to establish trust in new people. So, for example, if two trusted friends are already friends with a 3^{rd} person, and possibly even vouch for that 3^{rd} person, there is a good chance that a user may trust this 3^{rd} person quickly. Accordingly, if there is not a good central authority of public keys that process 100 can use for validating some stranger's public key, process 100 can use this method of transitive trust.

If a user sees a stranger's public-key, and at least two (e.g. or K) individuals they already trust (e.g. because of past interactions with them) also trust this stranger (e.g. because of their own past interactions with the stranger), the user can also agree to establish a trust relationship with this stranger automatically. The user can decide to use an arbitrary number K to configure in the trust policy. In fact, the user can use not only use a combination of K pre-trusted other intermediary users as a bridge to establish trust, but they can also use an arbitrary combination of other trusted sources in conjunction with other users.

In one example, a user or enterprise-administrator can configure a policy to rely on at least one centralized service in combination with two (2) other individuals before trusting a stranger's public key. This type of model simulates the real-life behavior of relying on a combination of certificates issued by designated government authorities in combination with affidavits from known individuals, etc. Any such arbitrary policy can be constructed as desired by the user or enterprise to ensure they can encode a safe enough mechanism that automates the process for most users without having to manually check and verify each and every user, which nobody does due to its impracticality.

Process 1000 can implement manual self-verification. The final and strongest frontier to ensure safety is of course manual verification as used by WhatsApp and even Zoom (e.g. besides centralized automatic verification which is the weakest). Users may have a choice to resort to this for specific scenarios where they need to use extreme caution, irrespective of what automated mechanism is being used for most of the common cases.

Process 1000 can implement end-to-end encryption of meta-data between administrator-panel and SDK. Since the DigiLockbox system is designed to be used for consumer as well as enterprise use-cases, the administrator for configuring and managing policies is different in each case. For consumer use-cases, the user themselves is the ultimate administrator of their data, while the service-provider itself could exercise some limited controls on behavior depending on the service-tier etc. For enterprise use-cases, the enterprise administrators have ultimate control of employee data being created and consumed on behalf of the enterprise. For exercising these controls, a separate administrator-panel functionality can be utilized, which can either be incorporated in the application itself, or it could be made available as a separate app (e.g. web-application and/or native-application, etc.). Now since these administrator-controls will need to be passed back and forth between the administrator-panel and the SDK for enforcement of configuration via DigiLockbox backend service, process 1000 can ensure that even this config meta-data is kept end-to-end encrypted in such a way that the DigiLockbox backend service can't view it or tamper with it.

It is noted that depending on the configuration, it may be accessed by the application only, or by employees of a company only, or certain groups within a company. Accordingly, there is some policy enforcement that needs to happen on the meta-data between the administrator-panel and the SDK using encryption, similar to how the data itself requires policy-enforcement via encryption. By using the same mechanism for encoding policy into config meta-data as that used for actual data, process 1000 can take the trustless model to even the next level where the centralized service doesn't need to be trusted for anything at all. The only piece of code that needs to be trusted in the entire system is the SDK code, and that is something that process 100 can put in public domain for anybody and everybody to scrutinize and verify, ensuring that there is no chance of mess-up, and even if there are any bugs or vulnerabilities in this code while encoding policy, these are caught quickly. It is noted that as long as the code encoding policy is doing the right thing, the policies are enforced correctly at the time of access even if the policy enforcement logic at access time is using buggy or intentionally malicious code.

Process 1000 can provide user and device independence for policy vs. lockbox access. Process 1000 can encode user lockboxes with user-specific keys to keep them independent of end-devices and enabling secure access on multitude of devices owned by the same user through device-specific keys yet communicating securely on user's behalf via proxy re-encryption technique. A DigiLockbox solution to this problem can be to use a cryptographic technique called Proxy Re-encryption and/or Transform Encryption. This technique can used between two users, with a semi-trusted 3^{rd}-party intermediating access between the two users to act as a proxy for User-A wanting to share selective data with User-B. User-A can generate a transform key for User-B using its own private-key and User-B's public-key, and hand it over to the semi-trusted intermediary, such that the intermediary 3^{rd}-party can use this transform-key to re-encode data encrypted for User-A to User-B's public-key so that User-B would be able to decode it. The intermediary does not have access to the data, so it does not need to be trusted. The main advantage of this scheme is that by semi-trusting the intermediary, User-A can use it to grant temporary access to User-B, and whenever User-A wants to revoke access, it can ask the intermediary to delete the transform-key. In The DigiLockbox solution for User and Device separation, User-A is the actual user, User-B is one of the devices belonging to that user, and the semi-trusted 3^{rd}-party intermediary is the DigiLockbox server. In this way access policies involving a user can be encoded into encryption using their user-specific public key, and then the user can generate a transform-key for each device they own, which can be kept on DigiLockbox server for re-encoding the data encryption keys from user's public key to device-specific public-key. Each device can use its own device private key to decode the transformed data encryption keys being sent to it.

The user-key does not need to change (e.g. unless compromised) and access policies can be encoded into encryption using user's public key, while encryption/decryption at the device happens using device-specific private-key which never leaves the secure enclave of the device after being generated there. A user can generate a new transform-key using their user private key whenever they want to add a new device to their account, and deposit it with DigiLockbox server to act as intermediary between the user and the device. When-ever any user wants to remove a device from their account (e.g. because of a lost/stolen device), they simply revoke the transform-key for that device from the DigiLockbox server, without the entire system needing to be notified of the list of revoked-devices (like it happens in Zoom). Each user can use any number of devices as primary devices, with equal capabilities, without having restricted to a single primary device, etc.

Moreover, with user key being of more permanent nature, the trust-bridges on public keys can be built much-more reliably using different sources, as otherwise a new trust relationship would have to be established with the user for their peers when-ever their user key changed.

Process 1000 can encode arbitrary access policy into encryption. Process 1000 can encode arbitrary access control lists through a hierarchy of lockboxes created with a combination of symmetric and asymmetric cryptographic techniques, with the desirable property of being able to change the policy without touching the data-objects it applies to.

In this way, the DigiLockbox has devised a method for creating and enforcing arbitrary authorization policies on data objects without having to rely on any trusted servers, including for validation of user identities.

The resulting solution can be used by developers of both centralized/Web2.0 applications and even decentralized/Web3.0 apps so that they can enable secure private-sharing of data and make their systems virtually hack-proof and breach-resistant against most of the modern cyber-threats. This solution for arbitrary access policies can be further enhanced for solving some of the following problems that are applicable to even broader use-cases:

Giving temporary access for some data and revoking it either manually or automatically based on timed grant.

Interoperation and integration with other useful encryption techniques like homomorphic encryption, and confidential compute to enable server-side processing of data. Both these techniques are very complementary to a generic model of encrypting data on the client side with desired policies, which can be expanded to include these methodologies in appropriate use-cases. For example, locking the data using two different encryption keys, one with stronger security for permanent storage, and one for homomorphic computation by server, or conducting the integrity check on code to be executed in TEE before releasing the decryption key for confidential computation on the server.

Process 1000 can be used for protecting user private key securely and conveniently. Process 1000 can generate a strong envelope around user's private key, to protect it from brute-force attacks, by using Shamir's Secret Sharing (SSS) technique on multitude of easy-to-remember passwords, with each one being possibly weak on its own, effectively creating the security of a strong password.

The DigiLockbox solution is to use cryptographic technique of Shamir's Secret Sharing (SSS) to create a complicated and strong secret by combining a multitude of simpler, and possibly weak secrets, to protect the user account. Since this technique uses N total secrets chosen by the user, out of which at least K have to be correct to generate the original combined secret, the user can choose simple and easy to remember passwords for each one of the N secrets. Since the final secret needed to decrypt user's key is a combination of these N secrets, it will automatically generate a complex and strong secret for the user even if the individual passwords are themselves weak. It is noted that the cryptographic technique of SSS is well known and typically used to split a single secret across multiple people such that a single person cannot retrieve the original secret on their own. In one case, which can be taken and applied in a unique non-obvious way to split user's primary secret across a multitude of simple, and easy to remember, passwords owned by the same user, which simulates the generation of a complex and strong password. The user also has some leeway in the sense that even if they have up to (N-K) passwords, they can still access their account. For the hacker, it will still be more difficult to guess K different passwords (e.g. which is more than two (2) needed for Apple Keychain), especially considering that nobody knows which of the K passwords entered by the user are correct when they login, or even how many of them are correct, as long as at least K are indeed correct. This keeps control of the user's account completely in their own hands, without relying on a single password and, more importantly, without having to trust any centralized service.

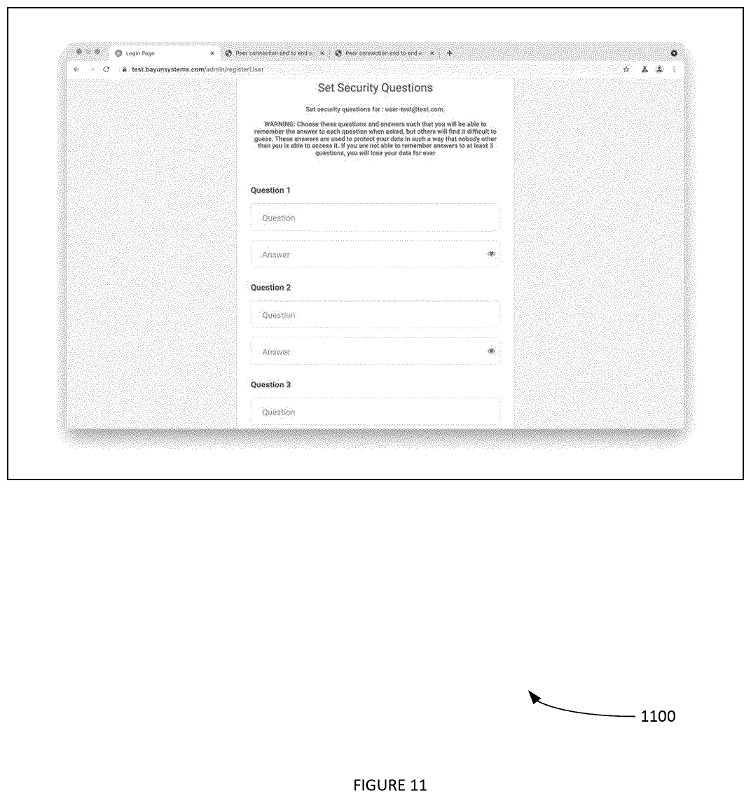

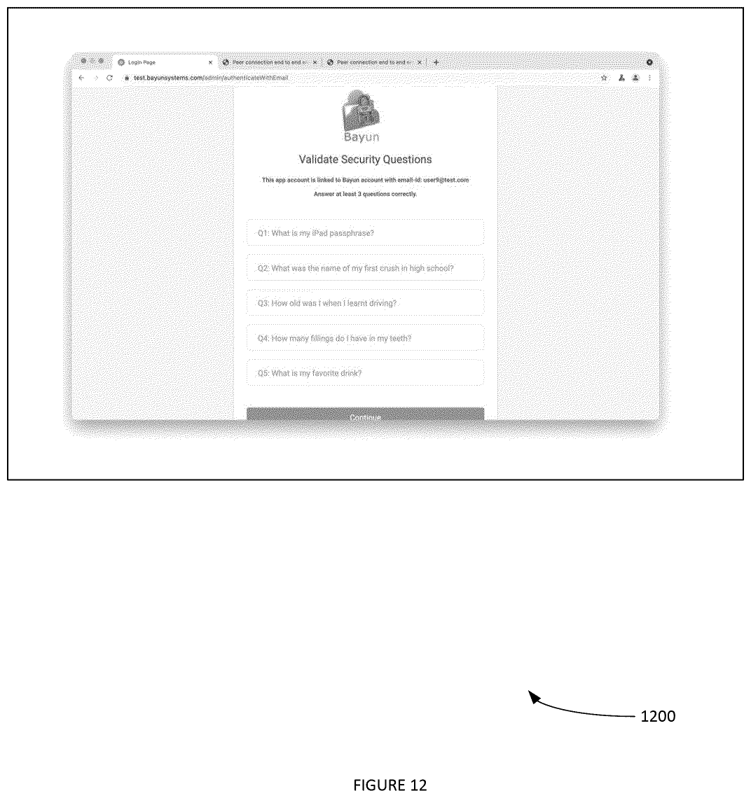

FIGS. 11 and 12 show screenshots 1100-1200 show the scenario where user is being asked to choose five (5) different passwords (so N=5), out of which at least 3 may need to be correct (e.g. K=3) for a fresh login from a new device, according to some embodiments.

It is noted that in another variation, instead of presenting the five (5) questions to the user at the time of login and asking them to enter answers with at least three (3) answers needing to be correct, the user could be presented with three (3) (or even four (4)) randomly selected questions out of a total available of five (5).

In yet another most generic variation, the user could decide on their own what the values of N and K they want to choose. Some users could even choose K=N when they are sure that they will not forget anything.

In another variation, to give less choice to the user, the application could offer a standard set of questions to the user to choose from (e.g. via a dropdown list) instead of allowing them to enter a completely freeform input field for each question.

Process 1000 can use facial recognition (FR) with an end-to-end encrypted FR model. Process 1000 can use a phishing-resistant 2^{nd} factor while the user is trying to login from a new device and an existing device is not available. Facial recognition on the server-side is the easiest and most-convenient phishing-resistant technique available for this, as most devices these days already have a built-in camera (e.g. even if not, a special one-time-use magic-link can be sent to user's phone-number or email address for verification of their face-ID from another device that does have a camera). A concern with use of facial-recognition on the server-side like this is the potential privacy issues with storing the face-model of users on a trusted server. Even though the actual image of the user's face is not stored on the server, and only a model/fingerprint generated from the facial image is stored, this model is still highly personal information for the user. There is a risk with leakage of this personal information if the server haves compromised/breached. In order to address this privacy concern, process 1000 can use the DigiLockbox technology on the FR-model itself so that the server is not able to access the face-model without user's permission. This recursive use of the DigiLockbox ensures that even if the DigiLockbox server keeping FR-models is compromised, no personal data of users is at risk considering that even these FR-models are kept encrypted with user-specific encryption key. In order for a hacker to even have access to the user's face-model, they can have to break into not just the server storing these FR-models, but also break into user's multitude of passwords through a phishing attack. Even after having access to a single user's face-model through this process (every user's face-model is kept encrypted with a different user-specific key), the hacker still can't have access to the user's lockbox because the server will still need to match user's face against the model that it knows. This model provides the best protection against even the phishing attacks, without compromising on user's personal information even in the event of a server breach.

Process 1000 can implement a secure lockbox transfer via restricted backdoor. For the enterprises, one of the big concerns with giving control directly to employees in a decentralized manner, like what DigiLockbox enables, is that the employer itself could end up losing control of some data in certain situations.

Process 1000 can create a backdoor controlled by multiple administrator users of the company (e.g. N) without trusting any single central service or point in the entire system. A high-security transaction is executed for every such use of the backdoor, with full transparency in front of N authorized administrators out of which at least K need to provide approval, and any one of the N administrators can veto to cancel the transaction at any point before it is fully executed. Even after full authorization from at least K administrators, the transfer of enterprise owned data (e.g. via specific employee key) is done to a designated target employee of the company who needs to accept the data of departed employee, and not any of the authorizing administrators. Also the N authorized administrators can even be put under different administrative controls, so that not only at least K administrators need to collude to access the backdoor, these administrators are not under same control hierarchy either, or even then the data itself is never transferred to any of them. The backdoor for an enterprise can only be able to transfer the employee-specific key of the departed user which controls user-data owned only by that enterprise. So if the user were involved with multiple organizations in different capacities, either as an employee, or as a contractor, partner etc., each organization will have a different employee-key designated for use by the same user. So even the same application could maintain different employee-specific keys for the same user for managing the data under different user accounts.

In one example, the same user could be using Gmail® application on their phone, and they could have multiple accounts on behalf of different employers, and also a personal gmail.com account for their individual use. The user itself can have a single user-key for the Gmail application being used in this case, but every account can have its own separate employee-key specific to the employer who owns that account, and user-data is controlled by the employee-specific key. The employee-specific keys of the user are made available to respective backdoors of each organization after consent from the user before they are allowed to access company's data, and the employee-key of the user's personal account is not made available to any organizational backdoor and kept under control of the individual user-key itself.

For achieving this entire scheme, process 1000 can use another cryptographic technique called Multi Party Computation (MPC). It is a more general version of SSS technique that enables the backdoor to be split into N users, such that at least K users need to execute their authorization through threshold signatures (e.g. at least a threshold of signatures needs to be obtained) in order to unlock the backdoor. Process 1000 can use a generic technique and uniquely combined it with the element of transparency and employee-specific private keys for each user (e.g. if a user is acting on behalf of multiple organizations, they will have a separate private-key for each organization) to enable an enterprise-level backdoor in a secure way.

Another potential use of such a secure backdoor is for individual account recovery in consumer use-cases, where the backdoor for every user could be controlled by a different set of N designated “nominees” instead of same N administrators controlling the enterprise backdoor of an entire organization. In this case, a user themselves could choose N nominees, who they want to designate for securely recovering their account in case they themselves have locked out or incapacitated, such that at least K nominees need to authorize the account recovery. This mechanism can also be used to securely pass on the digital estate assets of the user to the next of the kin in case of their death.

Process 1000 can decentralize public key verification for data sharing. Process 1000 an detect and prevent harm even if the authoritarian servers of an application (e.g. authentication layer or authorization code inside the application) and other systems they rely on (e.g. email/SMS services for OTP delivery) have been taken over by a malicious entity (e.g. rogue state sponsored intrusion).

Process 1000 can provide/manage a flexible system that can be customized/configured in a decentralized manner by the individual user and/or enterprise administrator to suit their needs. DigiLockbox can incorporated an identity verification system, which works in conjunction with several other public and private systems, for users or enterprise-administrators to be able to themselves configure and specify what kind and level of user identity verification they are willing to trust from different available sources, for any strangers (e.g. who they have never communicated with earlier). It then gives them an indication of the current validation level (e.g. in different bands of red, yellow, green, etc.) at which each user's identity has been verified before they decide to trust them. The validation level of a user's identity can also move up over time, as it has been verified by more independent sources.

The following list shows different independent sources of identity verification that can be used in combination by any user or enterprise-administrator to configure which sources they are willing to trust for a stranger. Once a trust relationship has been established for a user with another entity, that entity is not considered stranger for that user anymore. Their public key is self-signed by the user, along with the source that was used to validate the identity of the entity, so that it can be reused by the user even on a different device without having to establish trust with same entity again. The only reason to reestablish trust would be in case the public key of the entity changes for some reason, and in that case the system starts treating the new identity of the entity as a stranger again, having to go through the same policy of establishing trust from scratch. The DigiLockbox uses user or entity specific public keys that are managed independently of device-keys, which makes it extremely rare for a public key of a user or an entity to change. Note that even though the following sources are roughly in order of increasing trust level, the actual trust level for each user would be governed by policy configured for them (e.g. either by themselves or by their employer).

Process 1000 can provide a trusted service from the service-provider. This can be the easiest source of trust, as the service-provider could easily provide a centralized database of public-keys to be used by its users irrespective of what identity provider is being used by each customer enterprise, and whether the identity service provides a mechanism to maintain and validate public keys.

For example, Zoom may provide this as the only mechanism up to phase-3 of their implementation. However, as discussed above, this centralized service now becomes the single point of vulnerability in the entire system, defeating the whole purpose of using end-to-end encryption in the first place.

Process 1000 can provide a trusted identity server under control of the enterprise. The DigiLockbox model may remove trust in the service provider (e.g. Zoom), but it shifts the burden of trust to the identity-provider chosen by the enterprise (e.g. Okta). So even though it helps a little bit in the sense that the service-provider itself is no longer vulnerable, now the vulnerability shifts to the identity-providers instead.

Process 1000 can provide trusted administrator-approval of the enterprise. The DigiLockbox model allows an enterprise-administrator to explicitly attest public-keys of the company's employees while approving them for onboarding, and this can be done without trusting any centralized service. Accordingly, the public key of the employee being onboarded is signed directly by a key under control of the enterprise-administrator, where this enterprise administrator key is not available to any centralized service. This does away with trust in any centralized server, as only specific administrators or administrator-controlled keys are trusted by the system. This works pretty well for employees of the same enterprise but is a bit challenging to scale for cross-company collaboration in an environment where many different companies are involved, with different administrators controlling and certifying public keys of different company's employees. In this case, a combination of this technique with another source has to be used in order to establish trust in the administrator keys of other companies, which can then be used to establish trust in employees of those companies.

Process 1000 can provide key transparency and/or equivalent. A public or private key-discovery service with tamper-proof mechanism to ensure that the public-key of a user being looked-up has not been compromised. An enterprise or a user may be willing to trust one or more of such services, which can be configured as policy in the DigiLockbox SDK so the public keys of strangers can be pulled-in from one or more of such sources, if available, to establish trust. Considering that these databases are still rather sparse, so if none of the such trusted sources have the public key of the user being looked-up (or if the user/enterprise is not willing to trust any of such sources despite their tamper-proof nature), process 100 can use other sources instead.

Process 1000 can provide blockchain based decentralized identity. There are efforts in place to create a completely decentralized identity management system on top of blockchain, with users themselves in full control of their identity. The use of blockchain ensures that no centralized service needs to be trusted to even maintain an auditable log, so even if one or more service-provider(s) of some node(s) in blockchain goes down, the service still stays operational (e.g. which can't be said for Key Transparency for example). The decentralized nature and immutability of blockchain technically ensures that the keys are indeed tamper-proof. However, such services are still in their infancy, and mostly targeting consumer use cases rather than enterprise use-cases. As and when these services evolve, DigiLockbox can incorporate them and make them available to users and enterprises as a configurable source of public keys to establish trust.

For example, a user or enterprise-administrator can configure a policy to rely on at least one centralized service in combination with 2 other individuals before trusting a stranger's public key. This type of model simulates the real-life behavior of relying on a combination of certificates issued by designated government authorities in combination with affidavits from known individuals, etc. Any such arbitrary policy can be constructed as desired by the user or enterprise to ensure they can encode a safe enough mechanism that automates the process for most users without having to manually check and verify each and every user, which nobody does due to its impracticality.

Process 1000 can enable manual self-verification. The final and strongest frontier to ensure safety is of course manual verification (besides centralized automatic verification which is the weakest). Users should always have a choice to resort to this for specific scenarios where they need to use extreme caution, irrespective of what automated mechanism is being used for most of the common cases.

Process 1000 can provide end-to-end encryption of meta-data between administrator-panel and SDK. Since The DigiLockbox system is designed to be used for consumer as well as enterprise use-cases, the administrator for configuring and managing policies is different in each case. For consumer use-cases, the user themselves is the ultimate administrator of their data, while the service-provider itself could exercise some limited controls on behavior depending on the service-tier etc. For enterprise use-cases, the enterprise administrators have ultimate control of employee data being created and consumed on behalf of the enterprise. For exercising these controls, a separate administrator-panel functionality can be utilized, which can either be incorporated in the application itself, or it could be made available as a separate app (e.g. web-app and/or native-app, etc.). Now since these administrator-controls may need to be passed back and forth between the administrator-panel and the SDK for enforcement of configuration via the DigiLockbox backend service, the config meta-data can be kept end-to-end encrypted in such a way that the DigiLockbox backend service can't view it or tamper with it.

Again this is something that is not straight-forward, because depending on the configuration, it could need to be accessed by the application only, or by employees of a company only, or certain groups within a company. So there is some policy enforcement that needs to happen on the meta-data between the administrator-panel and the SDK using encryption, similar to how the data itself requires policy-enforcement via encryption. By using the same mechanism for encoding policy into config meta-data as that used for actual data, the trustless model can be evolved to a next level where the centralized service doesn't does not need to be trusted. The only piece of code that is to be trusted in the entire system is the SDK code, and that is something that can be put in a public domain for anybody and everybody to scrutinize and verify and even if there are any bugs or vulnerabilities in this code while encoding policy, these are caught quickly. It is noted that as long as the code encoding policy is doing the right thing, the policies are enforced correctly at the time of access even if the policy enforcement logic at access time is using buggy or intentionally malicious code.

Process 1000 can provide user and device independence for policy vs lockbox access. Process 1000 encodes one or more user lockboxes with user-specific keys to keep them independent of end-devices and enabling secure access on multitude of devices owned by the same user through device-specific keys yet communicating securely on user's behalf via proxy re-encryption technique.

Any system using asymmetric encryption to share data and keys between User-A and User-B has two choices: use user-specific key-pairs or use device-specific key-pairs. The advantage of using user-specific key-pairs is that, while sharing data User-A can just share data's encryption-key using User-B's public-key at the time of encoding policy into data encryption, and User-A doesn't need to worry about any of the devices User-B has. So policy-encoding logic can be built keeping in mind the set of users alone, completely ignoring the end-devices these users might be using. The disadvantage of using user-specific key-pairs is that the user's private key now needs to be brought-in securely to potentially multiple devices a user might be using, and stored securely on each device, to be able to do encryption/decryption using this user private-key. This is not desirable, as it is best to use device-specific key-pairs for encryption/decryption on the device, such that the private-key of the device is generated locally inside the secure enclave, and it never leaves the secure-enclave ever.

The DigiLockbox solution to this problem is to use a cryptographic technique called Proxy Re-encryption or Transform Encryption. This technique can be used between two users, with a semi-trusted 3^{rd}-party intermediating access between the two users to act as a proxy for User-A wanting to share selective data with User-B. User-A can generate a transform key for User-B using its own private-key and User-B's public-key, and hand it over to the semi-trusted intermediary, such that the intermediary 3^{rd}-party can use this transform-key to re-encode data encrypted for User-A to User-B's public-key so that User-B would be able to decode it. The intermediary does not have access to the data, so it does not need to be trusted. The main advantage of this scheme is that by semi-trusting the intermediary, User-A can use it to grant temporary access to User-B, and whenever User-A wants to revoke access, it can ask the intermediary to delete the transform-key. In the DigiLockbox solution for User and Device separation, User-A is the actual user, User-B is one of the devices belonging to that user, and the semi-trusted 3^{rd}-party intermediary is the DigiLockbox server. This way access policies involving a user can be encoded into encryption using their user-specific public key, and then the user can generate a transform-key for each device they own, which can be kept on DigiLockbox server for re-encoding the data encryption keys from user's public key to device-specific public-key. Now each device can use its own device private key to decode the transformed data encryption keys being sent to it.

This can provide the best of both worlds, as now the user-key never needs to change (e.g. unless compromised) and access policies can be encoded into encryption using user's public key, while encryption/decryption at the device happens using device-specific private-key which never leaves the secure enclave of the device after being generated there. A user generates a new transform-key using their user private key whenever they want to add a new device to their account, and deposit it with DigiLockbox server to act as intermediary between the user and the device. And when-ever any user wants to remove a device from their account (e.g. because of a lost/stolen device), they simply revoke the transform-key for that device from the DigiLockbox server, without the entire system needing to be notified of the list of revoked-devices. Each user can use any number of devices as primary devices, with equal capabilities, without having restricted to a single primary device, etc.

Moreover, with user key being of more permanent nature, the trust-bridges on public keys can be built much-more reliably using different sources, as otherwise a new trust relationship would have to be established with the user for their peers when-ever their user key changed. And things would have been much more cumbersome if device-specific keys are used for building these trust bridges. In fact it would even create a big vulnerability loophole in the whole system because any centralized service enabling onboarding of a new device could act as a weak point for hackers.

More specifically, process 1000 can include the following steps discussed supra. In step 1002, process 1000 can encode arbitrary access policy into encryption. In step 1004, process 1000 can protect user private key securely and conveniently. In step 1006, process 1000 can use facial recognition with end-to-end encrypted FR model. In step 1008, process 1000 can secure lockbox transfer via restricted backdoor. In step 1010, process 1000 can decentralize public key verification for data sharing. In step 1012, process 1000 can implement end-to-end encryption of meta-data between admin-panel and SDK 1012. Process 1000 implements user and device independence for policy vs. lockbox access 1014.

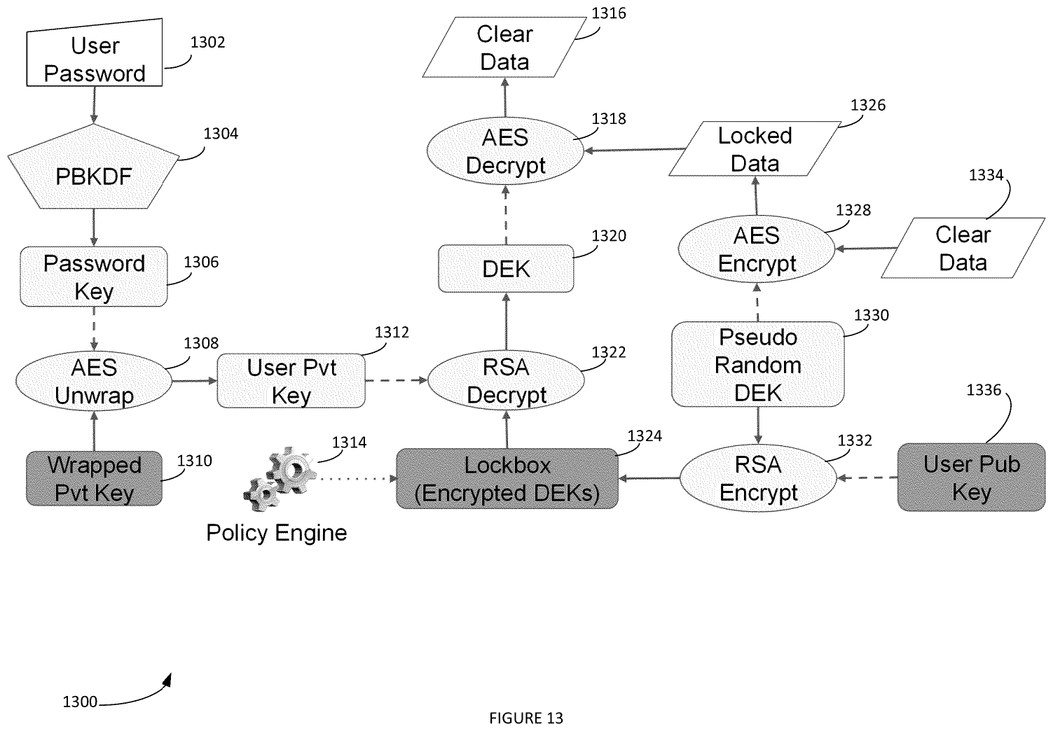

FIG. 13 illustrates an example process 1300 for basic locking/unlocking with lockboxes, according to some embodiments. Step 1302 shows a user password to protect user's Private Key, and indirectly all the data accessible to that user. This can be a user supplied passphrase, or a strong password generated by intermingling multiple security questions via Shamir's Secret Sharing technique. Step 1304 shows the technique of Password Based Key Derivation Function used to generate an encryption/decryption key from the User Password.

Step 1306 shows a Password Key generated from the User Password using Password Based Key Derivation Function. Step 1308 shows a process of unwrapping (decrypting) the wrapped (encrypted) private key of the user with Password Key using AES decryption algorithm.

Step 1310 shows a User Private Key kept encrypted with the Password Key generated from User Password. Step 1312 shows a User Private Key that decrypts contents of User's Lockbox containing all the decryption keys to the data or other lockboxes that the User has access to. Step 1314 shows a policy determined by the user or the enterprise to govern access to the User's Lockbox.

Step 1316 shows cleartext data obtained after decrypting the locked data for presenting to the User. Step 1318 shows the process of decrypting locked data with Data Encryption Key using AES algorithm. Step 1320 shows a Data Encryption Key used to decrypt the encrypted data.

Step 1322 shows a process of decrypting keys with User Private Key using RSA or ECC algorithm. Step 1324 shows a Lockbox of the User containing encrypted decryption keys for all the data or other lockboxes the User has access to. Step 1326 shows an Encrypted data that any User has access to.

Step 1328 shows a process of encrypting cleartext data with Data Encryption Key using AES algorithm. Step 1330 shows a random or pseudo random key generated to encrypt the cleartext data. Step 1332 shows the process of encrypting the Data Encryption Key with User Public Key using RSA or ECC algorithm so as to deposit the encrypted DEK into User's lockbox for safe storage. Step 1334 shows cleartext data generated by an application before it is encrypted or locked. Step 1336 shows a User Public Key used to encrypt encryption/decryption keys deposited into a user's lockbox using RSA/ECC algorithm.

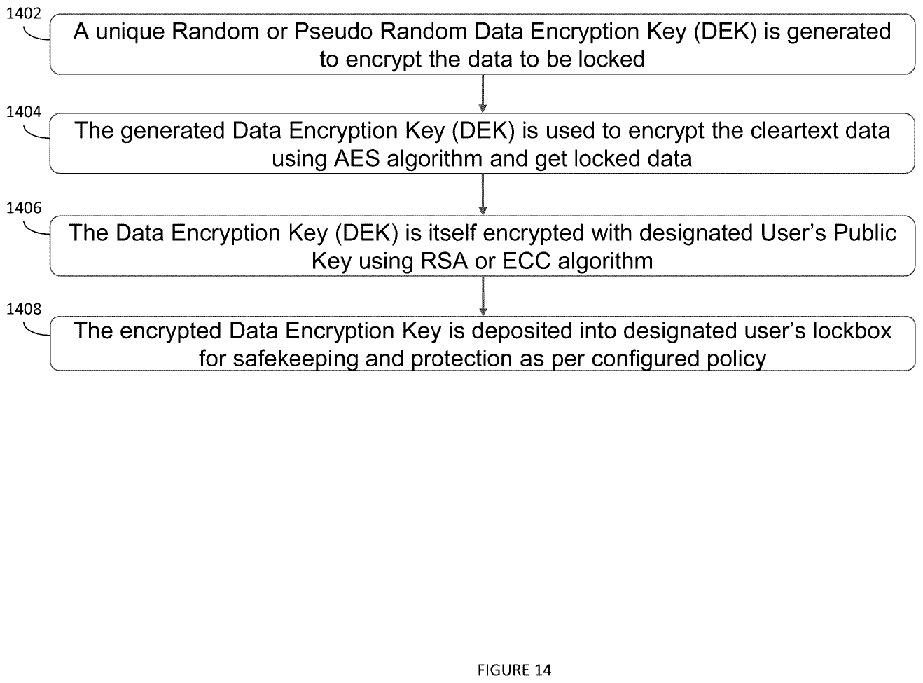

FIG. 14 illustrates an example process 1400 for implementing a basic data locking, according to some embodiments. In step 1402, process 1400 a unique random or pseudo random data encryption key (DEK) is generated to encrypt the data to be locked. In step 1404, the generated Data Encryption Key (DEK) is used to encrypt the cleartext data using AES algorithm and get locked data. In step 1406, the Data Encryption Key (DEK) is itself encrypted with designated User's Public Key using RSA or ECC algorithm. In step 1408, the encrypted Data Encryption Key is deposited into designated user's lockbox for safekeeping and protection as per configured policy.

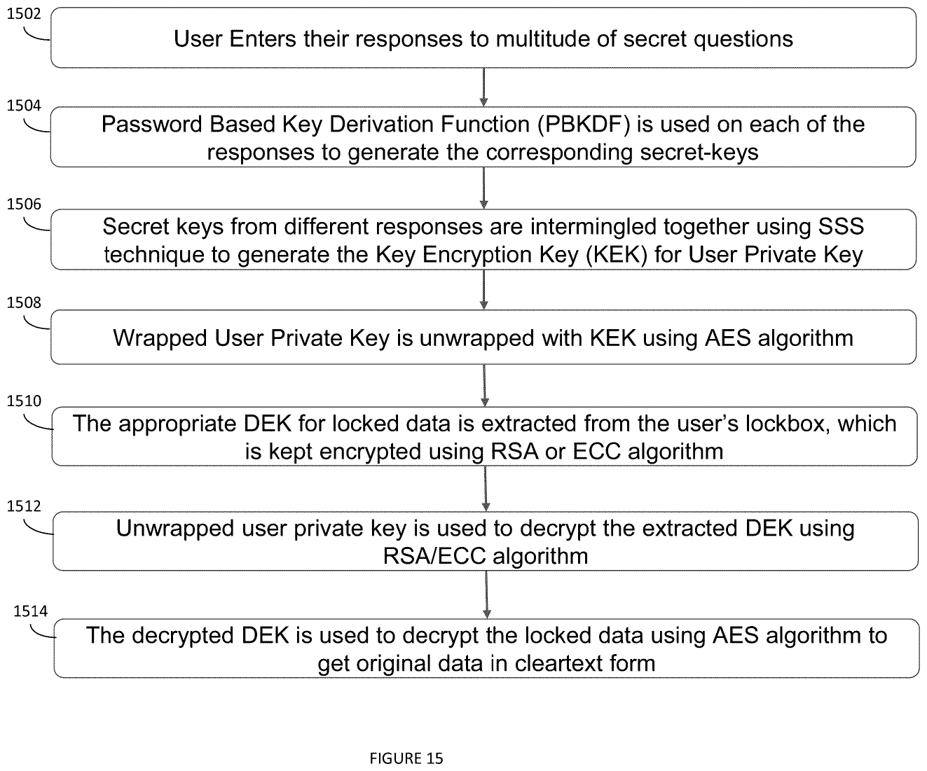

FIG. 15 illustrates an example process 1500 for Basic Data Unlocking, according to some embodiments. User Enters their responses to multitude of secret questions. In step 1502, a Password Based Key Derivation Function (PBKDF) is used on each of the responses to generate the corresponding secret-keys. In step 1504, secret keys from different responses are intermingled together using SSS technique to generate the Key Encryption Key (KEK) for User Private Key. In step 1506, a Wrapped User Private Key is unwrapped with KEK using AES algorithm. In step 1508, the appropriate DEK for locked data is extracted from the user's lockbox, which is kept encrypted using RSA or ECC algorithm. In step 1510, unwrapped user private key is used to decrypt the extracted DEK using RSA/ECC algorithm. In step 1512, the decrypted DEK is used to decrypt the locked data using AES algorithm to get original data in cleartext form. Processes 1400 and 1500 can be used to implement process 1300.

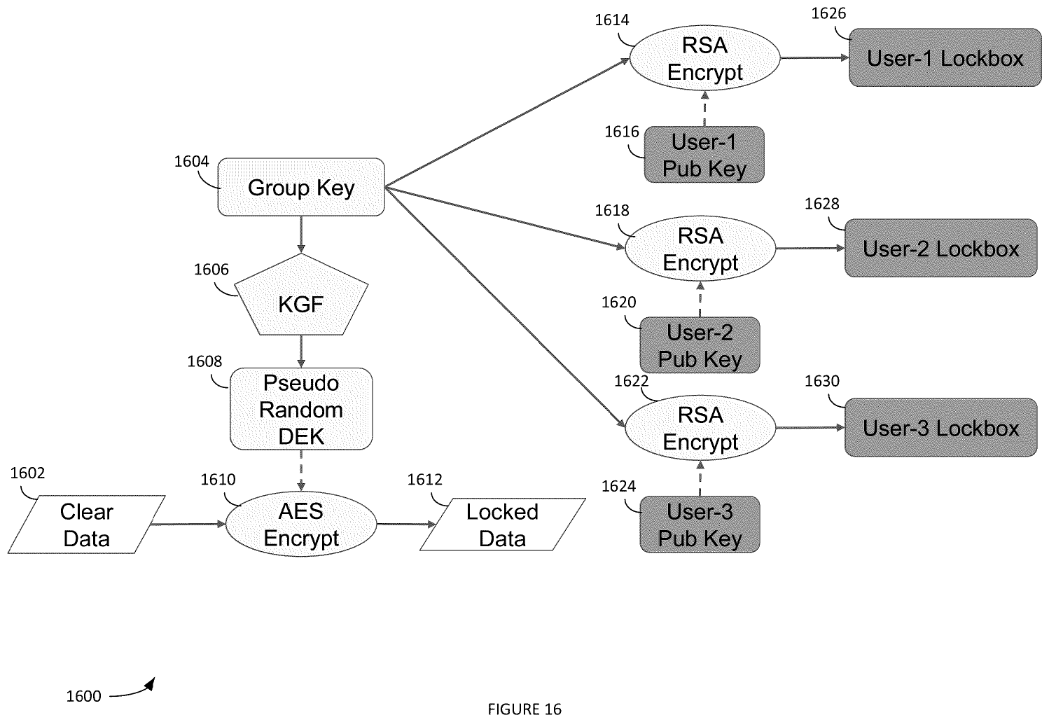

FIG. 16 illustrates an example process 1600 for locking with group access policy, according to some embodiments. In step 1602, cleartext data is generated by an application before it is encrypted or locked. In step 1604, the group's master key is used to generate or encrypt/decrypt data encryption keys for a particular group.

In step 1606, the Key Generation Function is used to generate a pseudo random key from the master key. In step 1608, a random or pseudo random key is generated to encrypt the cleartext data. In step 1610, the process of encrypting cleartext data with Data Encryption Key uses an AES algorithm.

In step 1612, the encrypted data that any user has access to. In step 1614, the process of encrypting Group's Master Key with User-1's public key uses an RSA or an ECC algorithm so as to grant access to the Group for the group member User-1.

In step 1616, the user-1's Public Key is used to keep contents of User-1's Lockbox encrypted. In step 1618, the process of encrypting Group's Master Key with User-2's public key using an RSA or an ECC algorithm so as to grant access to the Group for the group member User-2. In step 1620, the user-2's Public Key is used to keep contents of User-2's Lockbox encrypted.

In step 1622, the process of encrypting Group's Master Key with User-3's public key using RSA or ECC algorithm so as to grant access to the Group for the group member User-3. In step 1624, the user-3's Public Key is used to keep contents of User-3's Lockbox encrypted.

In step 1626, the lockbox of the User-1 containing encrypted decryption keys for all the data or other lockboxes User-1 has access to. In step 1628, the lockbox of the User-2 contains encrypted decryption keys for all the data or other lockboxes User-2 has access to. In step 1630, the lockbox of the User-3 containing encrypted decryption keys for all the data or other lockboxes User-3 has access to.

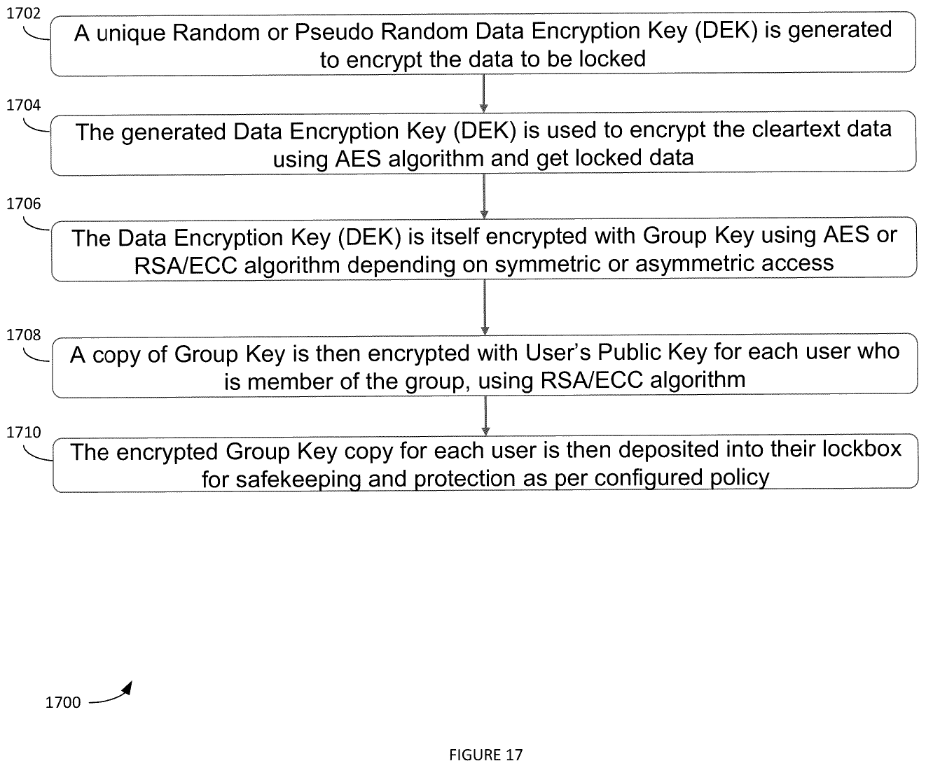

FIG. 17 illustrates an example process 1700 for locking with group access policy, according to some embodiments. In step 1702, a unique Random or Pseudo Random Data Encryption Key (DEK) is generated to encrypt the data to be locked. In step 1704, the generated Data Encryption Key (DEK) is used to encrypt the cleartext data using AES algorithm and get locked data. In step 1706, the Data Encryption Key (DEK) is itself encrypted with Group Key using AES or RSA/ECC algorithm depending on symmetric or asymmetric access. In step 1708, a copy of Group Key is then encrypted with User's Public Key for each user who is member of the group, using RSA/ECC algorithm. In step 1710, the encrypted Group Key copy for each user is then deposited into their lockbox for safekeeping and protection as per configured policy.

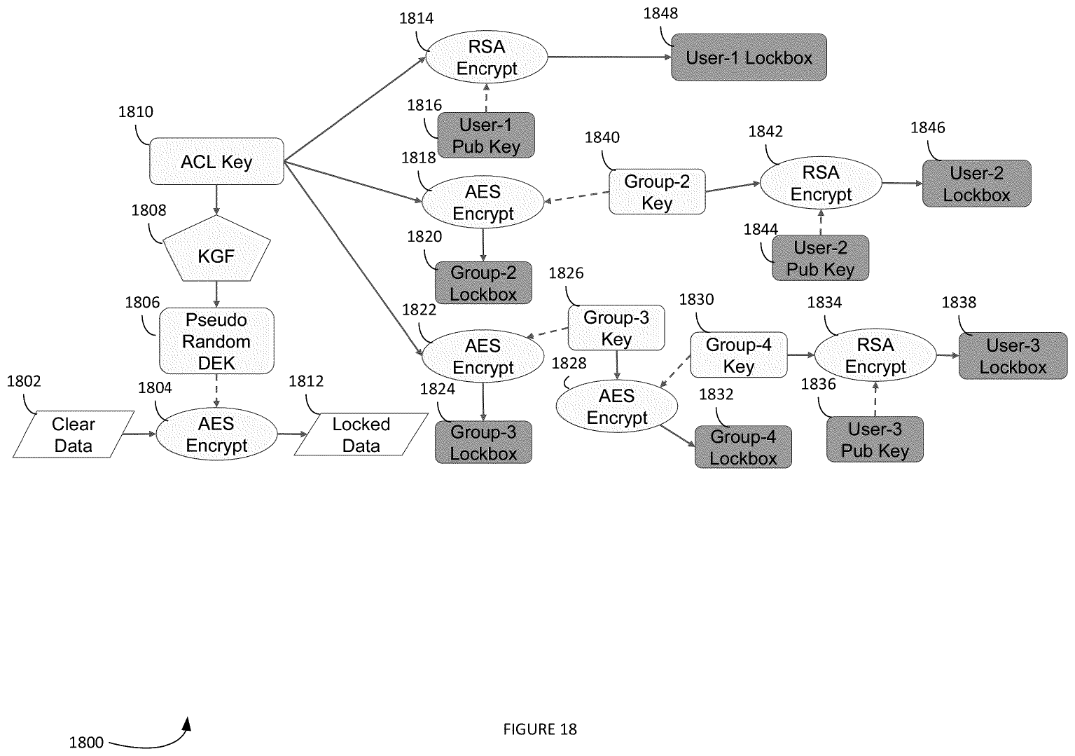

FIG. 18 illustrates an example process 1800 for locking with an arbitrary Access Policy (ACL), according to some embodiments. In step 1802, the cleartext data is generated by an application before it is encrypted or locked. In step 1804, the process of encrypting cleartext data is performed with Data Encryption Key using AES algorithm. In step 1806, a random or pseudo random key is generated to encrypt the cleartext data.

In step 1808, a Key Generation Function is used to generate a pseudo random key from the master key. In step 1810, an ACL's master key used to generate or encrypt/decrypt data encryption keys for a particular ACL. In step 1812, encrypted data that any user has access to is implemented. In step 1814, the process of encrypting ACL's Master Key with User-1's public key using RSA or ECC algorithm so as to grant access to the ACL for the ACL member User-1 is performed.

In step 1816, the user-1's Public Key used to keep contents of User-1's Lockbox encrypted. In step 1848, the lockbox of the User-1 containing encrypted decryption keys for all the data or other lockboxes User-1 has access to is implemented. In step 1842, the process of encrypting Group-2's Master Key with User-2's public key is implemented using RSA or ECC algorithm so as to grant access to the Group-2 for the Group-2 member User-2, thus granting indirect access to the ACL, that Group-2 itself is a member of, to User-2.

In step 1844, the user-2's Public Key used to keep contents of User-2's Lockbox is encrypted. In step 1846, the lockbox of the User-2 containing encrypted decryption keys for all the data or other lockboxes User-2 has access to is provided. In step 1840, the Group-2's master key is used to generate or encrypt/decrypt data encryption keys for Group-2.

In step 1818, the process of encrypting ACL's master key with Group-2's key using AES algorithm (or optionally using RSA/ECC algorithm for asymmetric access) so as to grant access to the ACL for the ACL member Group-2 is implemented. In step 1820, the lockbox of Group-2 containing encrypted decryption keys for all the ACLs or other groups that Group-2 is a member of is implemented.

In step 1822, the process of encrypting ACL's master key with Group-3's key using AES algorithm (or optionally using RSA/ECC algorithm for asymmetric access) so as to grant access to the ACL for the ACL member Group-3 is implemented. In step 1824, the lockbox of Group-3 containing encrypted decryption keys for all the ACLs or other groups that Group-3 is a member of is provided. In step 1826, the group-3's master key used to generate or encrypt/decrypt data encryption keys for Group-3 is provided.

In step 1828, the process of encrypting Group-3's master key with Group-4's key using AES algorithm (e.g. or optionally using RSA/ECC algorithm for asymmetric access) so as to grant access to Group-3 for the Group-3 member Group-4 is implemented, and hence indirectly granting access to the ACL for Group-4 because Group-3 is a direct member of the ACL.

In step 1830, the group-4's master key is used to generate or encrypt/decrypt data encryption keys for Group-4. In step 1832, the lockbox of Group-4 containing encrypted decryption keys for all the ACLs or other groups that Group-4 is a member of is provided. In step 1834, the process of encrypting Group-4's Master Key with User-3's public key using RSA or ECC algorithm is implemented so as to grant access to the Group-4 for the Group-4 member User-3, thus granting indirect access to the ACL, that Group-4 itself is an indirect member of via Group-3, to User-3.

In step 1836, the user-3's Public Key is used to keep contents of User-3's Lockbox encrypted. In step 1838, the lockbox of the User-3 containing encrypted decryption keys for all the data or other lockboxes User-3 has access to is implemented.

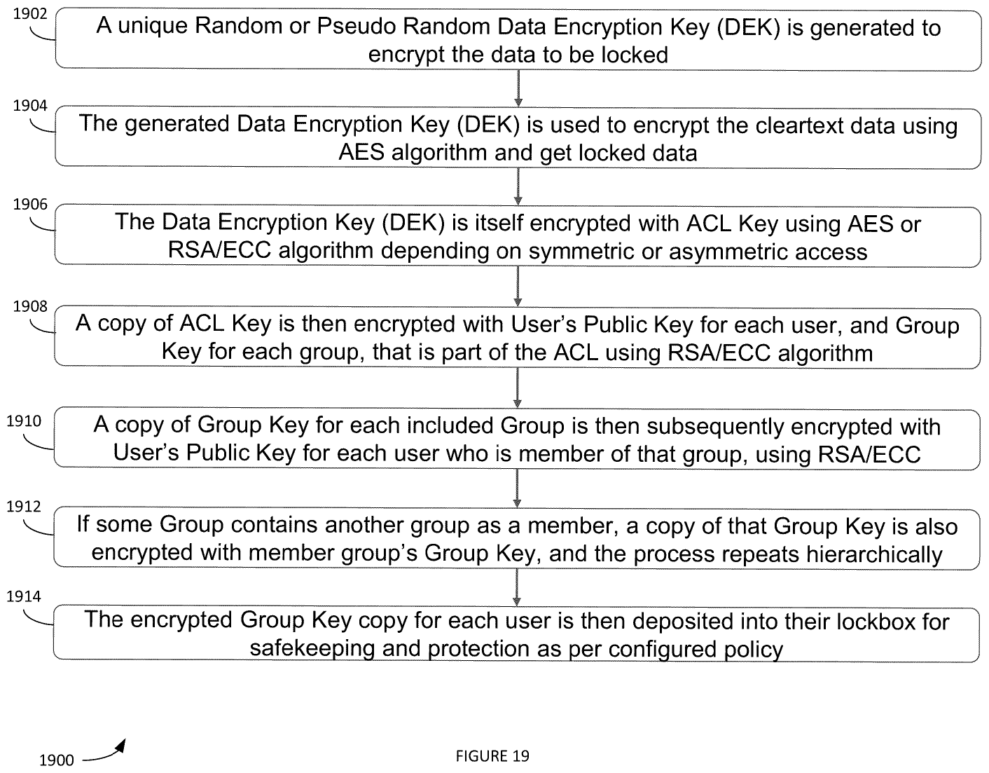

FIG. 19 illustrates another example process 1900 for locking with an arbitrary Access Policy (ACL), according to some embodiments. In step 1902, a unique Random or Pseudo Random Data Encryption Key (DEK) is generated to encrypt the data to be locked. The generated Data Encryption Key (DEK) is used to encrypt the cleartext data using AES algorithm and get locked data. In step 1904, the Data Encryption Key (DEK) is encrypted with ACL Key using AES or RSA/ECC algorithm depending on symmetric or asymmetric access.

In step 1906, a copy of ACL Key is then encrypted with User's Public Key for each user, and Group Key for each group, which is part of the ACL using RSA/ECC algorithm. In step 1908, a copy of Group Key for each included Group is then subsequently encrypted with User's Public Key for each user who is member of that group, using RSA/ECC. In step 1910, if some Group contains another group as a member, a copy of that Group Key is also encrypted with the member group's Group Key, and the process repeats hierarchically. In step 1912, the encrypted Group Key copy for each user is then deposited into their lockbox for safekeeping and protection as per configured policy.

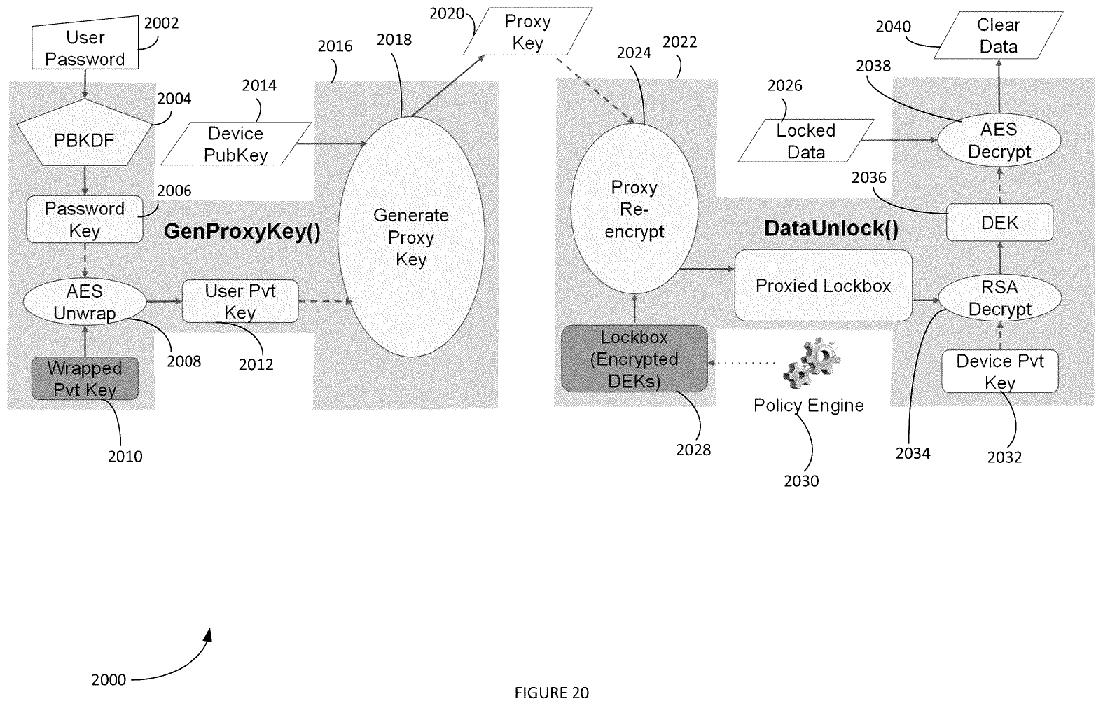

FIG. 20 illustrates another example process 2000 for use of Proxy Re-Encryption (PRE) for delegated policy enforcement on a device, according to some embodiments. Step 2002 shows a User Password to protect user's Private Key, and indirectly all the data accessible to that user. This can be a user supplied passphrase, or a strong password generated by intermingling multiple security questions via Shamir's Secret Sharing technique.

Step 2004 shows the technique of Password Based Key Derivation Function used to generate an encryption/decryption key from the User Password. Step 2006 shows Password Key generated from the User Password using Password Based Key Derivation Function. Step 2008 shows Process of unwrapping (decrypting) the wrapped (encrypted) private key of the user with Password Key using AES decryption algorithm.

Step 2010 shows User Private Key kept encrypted with the Password Key generated from User Password. Step 2012 shows User Private Key that decrypts contents of User's Lockbox containing all the decryption keys to the data or other lockboxes that the User has access to. Step 2014 shows the public key of the device where user data needs to be unlocked/decrypted for access by the user without directly using the user's private key on the device.

Step 2018 shows the process of generating a device-specific proxy-key from User Private Key (unwrapped using User Password) and Device Public Key, which can be used to re-encode user data for decryption on the device using Device Private Key alone.

Step 2016 shows the entire process of taking User Password as input and generating device-specific proxy-key from the Device Public Key. Step 2020 shows Device-specific proxy key generated from Device Public Key and User Private Key for use in proxy re-encryption algorithm. Step 2022 shows the complete process of unlocking user data on a device by using device-specific proxy key on the device without having direct access to user's private key.

Step 2024 shows the process of proxy re-encryption that takes User's lockbox content encrypted with User's Public Key and re-encrypts them using device-specific (and user-specific) proxy key such that the contents of resulting proxied lockbox can be decrypted with device's private key alone. Step 2028 shows Lockbox of the User containing encrypted decryption keys for all the data or other lockboxes the User has access to.

Step 2030 shows Policy determined by the user or the enterprise to govern access to the User's Lockbox. Step 2032 shows Device Private Key that decrypts contents of User's Proxied Lockbox, which has been re-encrypted for the device, containing all the decryption keys to the data or other lockboxes that the User has access to from that specific device. Step 2034 shows the process of decrypting keys with Device Private Key using RSA or ECC algorithm.

Step 2036 shows Data Encryption Key used to decrypt the encrypted data. Step 2038 shows the process of decrypting locked data with Data Encryption Key using AES algorithm. Step 2026 shows Encrypted data that any User has access to. Step 2040 shows Cleartext data obtained after decrypting the locked data for presenting to the User.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method of encoding an Arbitrary Access Policy into a data encryption, comprising:
providing an encryption/decryption mechanism for any arbitrary combination comprising a list of groups or any arbitrary combination comprising a list of users and groups by:
creating a hierarchy of lockboxes with a combination of a symmetric cryptographic techniques and an asymmetric cryptographic technique;
directly implementing with the hierarchy of lockboxes the encryption/decryption mechanism into a data encryption logic by:
setting an access policy for encoding into data encryption by the data owner or an administrator;
after encrypting the data with a data encryption key, and subsequently encrypting the data encryption key for appropriate user or application, or group, or company, or some arbitrary combination thereof, writing the encrypted key into an appropriate set of user or group lockboxes;
requesting a user key from lockbox as an attempt is made to access the data inside the application for presenting to the user;
reading the encrypted key from user lockbox; which after decryption leading to encrypted key of next lockbox in the hierarchy, till retrieval of encrypted data encryption key itself, and
returning the encrypted key retrieved from final lockbox for the final decryption operations inside an SDK integrated into the application, and
wherein a resulting data and one or more encryption keys of the resulting are encoded in a plurality of layers of encryption as per the hierarchy corresponding to the specified access policy, and
wherein once a policy is encoded into encryption, no trust is required in a centralized server to enforce these access policies, since data encryption keys are now controlled directly by the policy members.

2. The computerized method as in claim 1, wherein different types of access are provided for different users/groups/companies with read-write access, read-only access, or asymmetric write-only access where the writer loses access after locking the data.

3. The computerized method as in claim 1 further comprising:
incorporating a device-independent policy for encoding using a plurality of user-keys alone, and
implementing device-specific enforcement for decryption using device-keys without a need to invalidate/revalidate user keys on device changes by user.

4. The computerized method as in claim 1 further comprising:
allowing a change in a policy definition of an existing access-policy already configured, without touching the objects already encoded with the policy, by adjusting the lockbox and a plurality of key hierarchies appropriately such that the updated policy automatically takes effect on all the data objects already encoded with the policy.

5. The computerized method as in claim 1 further comprising:
directly implementing with the hierarchy of lockboxes the encryption/decryption mechanism into a key encryption logic, for a secure and trustless key-vault or Key Management Service (KMS), and without having to trust a centralized system.

6. The computerized method as in claim 5 further comprising:
combining the key-management with the data management with a Confidential Compute system on a server-side for a truly trustless end-to-end processing system,
wherein a computations is performed on the data in a server securely inside a trusted enclave (TEE) of the CPU, with the data encryption key remaining under exclusive control of the user or data-owner, with no possibility of bypassing even by a compromised authentication service, or any authorized logic.

7. The computerized method as in claim 5 further comprising:
combining the key-management with the data management with a homomorphic encryption for trustless processing of data without an automated system ever accessing an underlying unencrypted data.

8. The computerized method as in claim 1 further comprising:
implementing a recursive use of end-to-end encryption to maintain Facial Recognition (FR) model of the user private after user providing their facial image without an access by the server side to avoid privacy concerns, such that the user is the only one who can enable access of the Facial Model by the server for phishing-resistant biometric validation without compromising privacy of the facial model.

9. The computerized method as in claim 1 further comprising:
providing a plurality of enhancement of lockboxes to make them risk aware at the time of unlocking any lockbox to gain access to some decryption key for the user; and
creating a model of user behavior based on a plurality of specific usage patterns of the user, for usual unlocking of data by the user,
wherein an anomalous activity is detected while attempting to unlock the lockbox, and/or based on configured policy by the enterprise, protection level is automatically raised with additional authorization requirement.

10. The computerized method as in claim 1 further comprising:
generating a strong envelope around a user's private key using a Shamir's Secret Sharing technique on a plurality of simple passwords to generate a single complex secret through cryptographic intermingling of the multiple passwords; and
intermingling of a subset of originally configured passwords to reconstruct the complex secret for decrypting the envelope around user's private key.

11. The computerized method as in claim 10 further comprising:
encoding an arbitrary access policy into the encryption/decryption mechanism; and
combining the encryption/decryption mechanism with a secure storage of user's own lockbox private key to obtain end-to-end encrypted chain for user data, which disallows bypassing of encoded access policy even by hacked software or malicious administrator.

12. The computerized method as in claim 10 further comprising:
providing end-to-end encryption of control data or configuration data from admin-panel to SDK using a same recursive mechanism as used for protection of user data in combination with protecting administrator's configuration data and admin keys to provide full privacy even for controls and config-data, and also ensure that controls/config-data cannot be meddled with by a compromised server.

13. The computerized method as in claim 12, wherein a protection of administrator data and controls is combined with use of any of the various Multi Party Compute (MPC) techniques with threshold signatures to enable a plurality of transactions that enforce administrator controls in a decentralized manner such that a single hacked or malicious admin account cannot become the weak point to exploit the entire system or a multitude of user accounts.

14. The computerized method as in claim 13 further comprising:
using of a Shamir's Secret Service (SSS) as specific technique of MPC for protecting administrator data to provide decentralized administrative controls without relying on a centralized trusted server.

15. The computerized method as in claim 14 further comprising:
implementing a decentralized public-key validation of a stranger's public key, that is not yet trusted by the user, using one or more from a multitude of trusted services, which could be a centralized system controlled by an organization that the user trusts, or some decentralized identity service on top of a blockchain; or trusted friends of the user that are already in that user's trust circle leading to a chain of trust through friend of friends mechanism leading to inclusion of the stranger into that user's trust circle.

16. The computerized method as in claim 15 further comprising:
encoding an arbitrary access policy into the encryption; and
combining the encryption with the secure storage of user's own lockbox private key with trustless verification of stranger's public key to obtain a complete end-to-end security for user data, without requiring any trust in any centralized service what-so-ever such that even if the entire server-side infrastructure of an application were to be taken over by a malicious entity, the user data stays protected.

17. The computerized method as in claim 15 further comprising:
encoding the arbitrary access policy into the encryption; and
combining the encryption with the secure storage of user's own lockbox private key with trustless verification of stranger's public key to obtain complete end-to-end security for an enterprise's employee data, with end-to-end encrypted controls to obtain complete end-to-end security for an enterprise's data, without requiring any trust in any centralized service what-so-ever such that even if the entire server-side infrastructure of an application were to be taken over by a malicious entity, the enterprise data stays protected.

18. A computerized method comprising:
generating a strong envelope around a user's private key using a Shamir's Secret Sharing technique on a plurality of simple passwords to generate a single complex secret through cryptographic intermingling of the multiple passwords; and
intermingling of a subset of originally configured passwords to reconstruct the complex secret for decrypting the envelope around user's private key.

19. A computerized method comprising:
implementing a decentralized public-key validation of a stranger's public key, that is not yet trusted by the user, using one or more from a multitude of trusted services, which could be a centralized system controlled by an organization that the user trusts, or some decentralized identity service on top of a blockchain; or trusted friends of the user that are already in that user's trust circle leading to a chain of trust through friend of friends mechanism leading to inclusion of the stranger into that user's trust circle.
